(19) United States
(12) Patent Application Publication
(10) Pub. No.: US 2011/0207422 A1
(43) Pub. Date: Aug. 25, 2011

(54) ANTENNA APPARATUS AND RADIO TERMINAL APPARATUS

(75) Inventors: Yasumitsu Ban, Kawasaki (JP); Takashi Yamagajo, Kawasaki (JP)

(73) Assignee: FUJITSU LIMITED, Kawasaki-shi (JP)

(21) Appl. No.: 13/020,175

(22) Filed: Feb. 3, 2011

(30) Foreign Application Priority Data
Feb. 24, 2010 (JP) 2010-38584

(51) Int. Cl. H04B 1/034; H01Q 1/38

(52) U.S. Cl. 455/128; 343/700 MS

(57) ABSTRACT

An antenna apparatus, including: a substrate; an antenna element which is arranged on the substrate and transmits or receives a radio signal; a feed point which is connected to the antenna element and feeds a current or a voltage to the antenna element; and a wiring pattern, one end of which is connected to a ground pattern formed on a portion of the substrate, wherein two or more sets of the antenna element, the feed point, and the wiring pattern is included if the antenna element, the feed point, and the wiring pattern form one set.

### CROSS-REFERENCE TO RELATED APPLICATION

This application is based upon and claims the benefit of priority of the prior Japanese Patent Application No. 2010-038584, filed on Feb. 24, 2010, the entire contents of which are incorporated herein by reference.

### FIELD

The embodiments discussed here are related to an antenna apparatus and to a radio terminal apparatus.

### BACKGROUND

In conventional technology, diversity antennas is used as antenna apparatuses in which the same radio signals are received by for example two antennas, and reception signals from the antenna with superior radio wave conditions are preferentially used.

Further, a multimode antenna structure is known in which, by for example connecting a conductive connection element between two antenna elements, bypassing by the current flowing to the feed point of one of the antenna elements is caused, and the two antenna elements are electrically insulated.

Furthermore, an integrated-type flat-plate multi-element and electronic equipment are also known in which, by for example forming a cutout unit in an end unit of a ground pattern, the coupling between the antenna elements is reduced.

In addition, a compact-type portable terminal apparatus for radio reception is also known in which, for example, a variable reactance or switch is provided in a cut-out depressed unit of the rim unit of an upper ground conductor, and by means of the switch or similar, the correlation factors between antenna elements provided at the tip units of a plurality of protrusions in the upper ground conductor are reduced.
Patent Document 1: WO 2008/131157 A1
Patent Document 2: Japanese Laid-open Patent Publication No. 2007-13643
Patent Document 3: Japanese Laid-open Patent Publication No. 2007-243455

However, in the above-described techniques of the prior art, when a connection element is directly connected between antenna elements, the characteristics of the antenna elements change. Consequently by further arranging a matching circuit in the antenna apparatus, the reception frequency or transmission frequency can be kept in a prescribed range, accommodating the change in characteristics. However, if a matching circuit is arranged in the antenna apparatus, the number of components increases to this extent, and installation space for various elements and similar within the antenna apparatus is decreased. An increase in the number of components and decrease in installation space make it difficult to achieve reduced space usage or greater compactness of the antenna apparatus.

Further, in the above-described techniques of the prior art, when a cutout is provided in an end unit of a ground pattern, or a depressed unit is provided in an upper ground conductor, if the area of the cutout or depressed unit is equal to or greater than a specific size, the installation space for various elements and similar installed on the ground pattern is diminished by the amount of the cutout or similar.

On the other hand, by making the coupling, correlation or similar between antenna elements, or other antenna element characteristics equal to or greater than a specific value, the reception characteristics and similar of an antenna apparatus can be improved.

### SUMMARY

According to an aspect of the invention, an antenna apparatus, including: a substrate; an antenna element which is arranged on the substrate and transmits or receives a radio signal; a feed point which is connected to the antenna element and feeds a current or a voltage to the antenna element; and a wiring pattern, one end of which is connected to a ground pattern formed on a portion of the substrate, wherein two or more sets of the antenna element, the feed point, and the wiring pattern is included if the antenna element, the feed point, and the wiring pattern form one set.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a perspective view of an antenna apparatus;

FIG. 2A is a partial enlarged view of an antenna apparatus, FIG. 2B and FIG. 2c are cross-sectional views of the antenna apparatus;

FIG. 3 illustrates an example of simulation results for S₁₁;

FIG. 4 illustrates an example of simulation results for antenna efficiency;

FIG. 5A and FIG. 5B each illustrate an example of simulation results for a radiation pattern;

FIG. 6 illustrates an example of simulation results for correlation factors;

FIG. 7 illustrates an example of simulation results for S₂₁;

FIG. 8 is a partial enlarged view of an antenna apparatus for simulation;

FIG. 9 illustrates an example of current distribution;

FIG. 10A illustrates an example of simulation results for S₁₁, and FIG. 10B illustrates an example of simulation results for reactance;

FIG. 11 illustrates an example of a Smith chart;

FIG. 12A is a partial enlarged view of an antenna apparatus when there are no stubs, and FIG. 12B is a partial enlarged view of the antenna apparatus when there is one stub fold;

FIG. 13 is a partial enlarged view of an antenna apparatus;

FIG. 14 illustrates an example of simulation results for S₁₁ and S₂₁;

FIG. 15A illustrates an example of simulation results for S₁₁, and FIG. 15B illustrates an example of simulation results for S₂₁;

FIG. 16 illustrates an example of simulation results for correlation factors;

FIG. 17A and FIG. 17B each illustrate an example of current distribution;

FIG. 18 is a partial enlarged view of an antenna apparatus;

FIG. 19A illustrates an example of simulation results for S₁₁ and S₂₁, and

FIG. 19B illustrates an example of simulation results for correlation factors;

FIG. 20 illustrates an example of simulation results for current distribution;

FIG. 21A is a perspective view of an antenna apparatus, and FIG. 21B and FIG. 21C are cross-sectional views of the antenna apparatus;

FIG. 22A illustrates an example of simulation results for S₁₁, and FIG. 22B illustrates an example of simulation results for S₂₁;

FIG. 23 illustrates an example of simulation results for correlation factors;

FIG. 24 is a perspective view of an antenna apparatus;

FIG. 25A is an enlarged view of an antenna apparatus, and FIG. 25B and FIG. 25C are cross-sectional views of the antenna apparatus;

FIG. 26 is a front view of an antenna apparatus;

FIG. 27 is a front view of an antenna apparatus;

FIG. 28A illustrates an example of simulation results for S₁₁, and FIG. 28B illustrates an example of simulation results for S₂₁;

FIG. 29A and FIG. 29B are perspective views of a radio terminal apparatus;

FIG. 30A and FIG. 30B are perspective views of an antenna apparatus;

FIG. 31 is a perspective view of an antenna apparatus;

FIG. 32A and FIG. 32B each illustrate an example of a radio terminal apparatus;

FIG. 33 is a partial enlarged view of an antenna apparatus;

FIG. 34A illustrates an example of simulation results for S₁₁ and S₂₁, and

FIG. 34B illustrates an example of simulation results for correlation factors;

FIG. 35 is a partial enlarged view of an antenna apparatus; and

FIG. 36A illustrates an example of simulation results for S₁₁ and S₂₁, and

FIG. 36B illustrates an example of simulation results for correlation factors.

### DESCRIPTION OF EMBODIMENTS

Embodiments of the invention are explained below.

### First Example

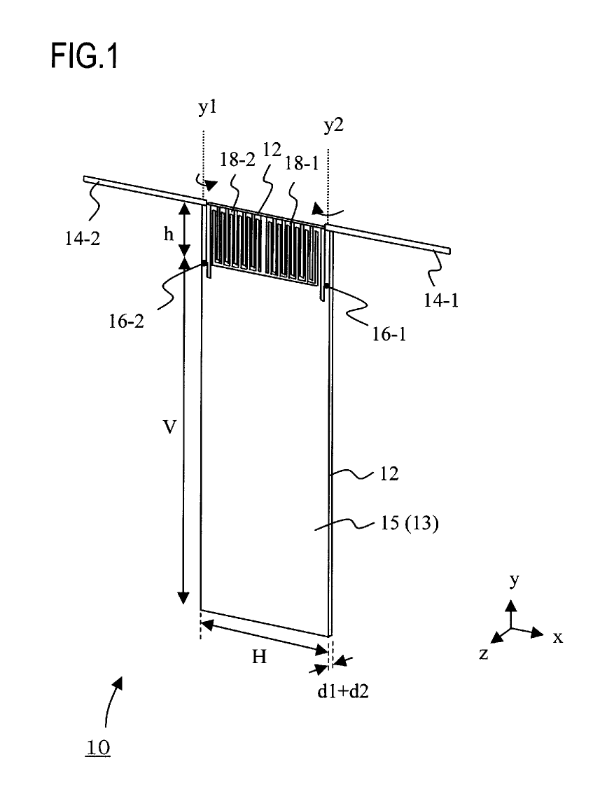

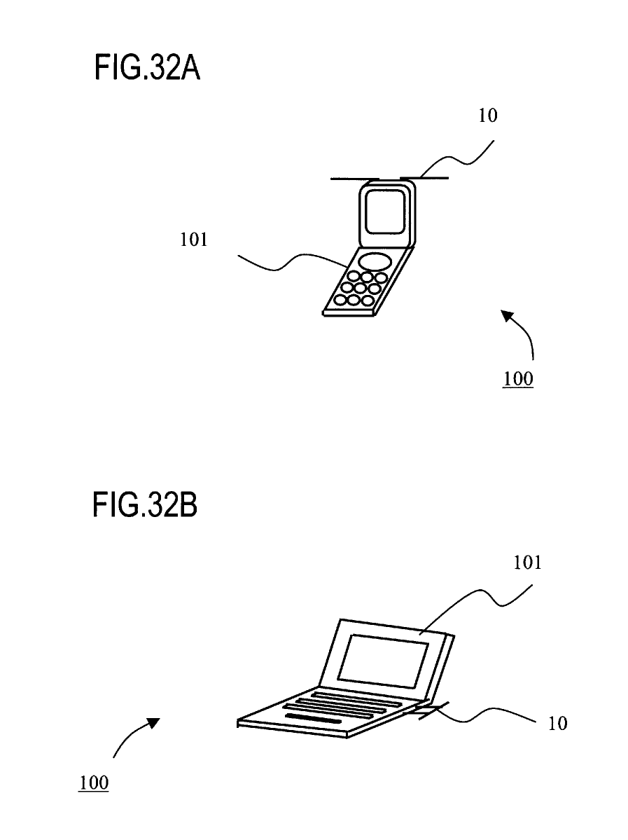

A first example is explained. FIG. 1 is a perspective view of an antenna apparatus 10. The antenna apparatus 10 is for example a card-type antenna apparatus, and can be loaded into or accommodated in a personal computer, a portable telephone, or another radio terminal apparatus. FIG. 32A and FIG. 32B illustrate a radio terminal apparatus 100; FIG. 32A and FIG. 32B illustrate examples of a portable telephone and a personal computer respectively as radio terminal apparatuses 100. The antenna apparatus 10 is accommodated within the housing 101 of the portable telephone 100, and can transmit and receive radio signals with a radio base station or similar. Further, the antenna apparatus 10 can be loaded into the housing 101 of a personal computer 100, and can transmit and receive radio signals with a radio base station or similar.

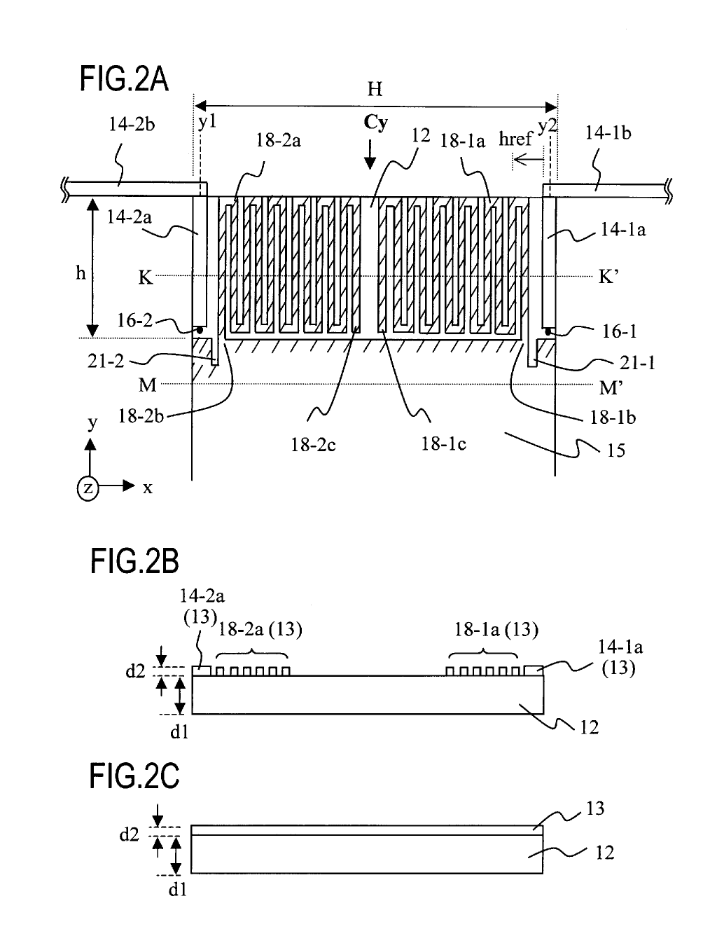

A configuration example of the antenna apparatus 10 is explained. FIG. 1 is a perspective view of the antenna apparatus 10, and FIG. 2A is a partial enlarged view of the antenna apparatus 10. Also, FIG. 2B is a cross-sectional view seen from the Cy direction upon sectioning the antenna apparatus 10 at line segment K-K′ in FIG. 2A, and FIG. 2C is a cross-sectional view, seen from the same direction Cy, upon sectioning the antenna apparatus 10 at line segment M-M′.

As illustrated in FIG. 1, the antenna apparatus 10 has a dielectric substrate (hereafter “substrate”) 12; two antenna elements 14-1 and 14-2 (or, first and second antenna elements 14-1 and 14-2); two feed points 16-1 and 16-2 (or, first and second feed points 16-1 and 16-2); and two stubs 18-1 and 18-2 (or, first and second stubs 18-1 and 18-2).

The substrate 12 has length “V+h” (for example, “80 mm”) in the y-axis direction, has length “H” (for example, “30 mm”) in the x-axis direction, and has length (or thickness) “d1” (for example, “1 mm”) in the z-axis direction. The substrate 12 has, on a portion of the top surface, a metal flat plate (or metal flat surface), such as for example a copper layer 13, and on the bottom surface, various elements.

The copper layer 13 has area V×H and thickness d2 (for example, “35 μm”), and forms a ground pattern 15 for the various elements and similar on the substrate 12. The antenna elements 14-1 and 14-2 are also formed from a conductive metal flat plate, such as for example a copper layer 13.

The antenna elements 14-1 and 14-2 receive radio signals transmitted from another antenna apparatus, and transmit radio signals to another antenna apparatus. The antenna elements 14-1 and 14-2 respectively have fixed units 14-1a and 14-2a (or first and second fixed units 14-1a and 14-2a) fixed on the substrate 12, and bent units 14-1b and 14-2b (or, first and second bent units 14-1b and 14-2b) bent into an L shape from the fixed units 14-1a and 14-2a.

The bent units 14-1b and 14-2b can be rotated about the y1 axis and y2 axis respectively, and can be accommodated within the width H of the substrate 12 (or antenna apparatus 10). Details of the bent units 14-1b and 14-2b are described below.

The feed points (or feed units) 16-1 and 16-2 are respectively arranged on the substrate 12 so as to be in contact with the fixed units 14-1a and 14-2a between the fixed units 14-1a and 14-2a of the antenna elements 14-1 and 14-2 and the ground pattern 15. The feed points 16-1 and 16-2 are connected to a power supply or similar via a feed line (for example a coaxial cable, stripline, or similar), and feed a current or voltage to the antenna elements 14-1 and 14-2.

The stubs 18-1 and 18-2 are for example conductive wiring patterns, and are distributed constant lines in a high-frequency circuit. As illustrated in FIG. 2A, the stubs 18-1 and 18-2 have meander units (or meander lines, or first and second meander units) 18-1a and 18-2a.

The meander units 18-1a and 18-2a are formed such that the copper layer 13 is bent alternately in concave or in convex shapes. The length in the y-axis direction (or the long-side direction) of the meander units 18-1a and 18-2a is “h” in the example of FIG. 2 and similar. Further, the meander units 18-1a and 18-2a are connected to the ground pattern 15 in the connection units 18-1b and 18-2b, and are formed to the tip units 18-1c and 18-2c. The tip units 18-1c and 18-2c are mutually separated, and are also separated from the ground pattern 15. The meander units 18-1a and 18-2a closest to the fixed units 14-1a and 14-2a of the antenna elements 14-1 and 14-2 are at a distance in the x-axis direction from the fixed units 14-1a and 14-2a which is equal to or less than a threshold value href.

As illustrated in FIG. 1 and FIG. 2A, in the antenna apparatus 10 are further arranged slits 21-1 and 21-2 (or, first and second slits 21-1 and 21-2) in a portion of the ground pattern 15. By means of the slits 21-1 and 21-2, the coupling between the antenna elements 14-1 and 14-2 and other characteristics are further improved.

In this way, the antenna apparatus 10 has, as two sets one set of a first antenna element 14-1, first feed point 16-1, and first stub 18-1, and one set of a second antenna element 14-2, second feed point 16-2 and second stub 18-2.

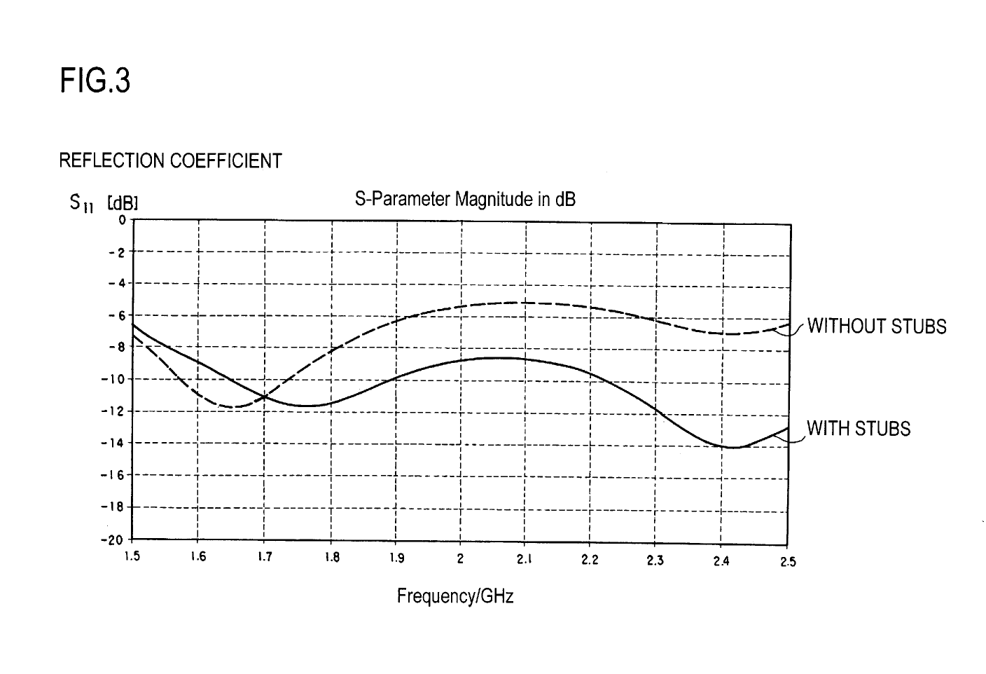

The inventor of this application performed various simulations for such an antenna apparatus 10. The results of simulations of the antenna apparatus 10 are explained below. FIG. 3 through FIG. 12B illustrate examples of simulation results and similar.

Of these, FIG. 3 illustrates an example of simulation results for the parameter S₁₁ (or the “reflection coefficient” or “matching”) among the S parameters.

In the simulations illustrated in FIG. 3, for example an AC voltage is applied from the first feed point 16-1 in the antenna apparatus 10 of FIG. 1 and similar. These simulation results were obtained by measuring this voltage and the voltage reflected at the first feed point 16-1 (or the first antenna element 14-1) at this time, when the frequency of the AC voltage is varied. The voltage supply is for example between the ground pattern 15 and the first feed point 16-1. In FIG. 3, the horizontal-axis indicates the frequency, and the vertical axis indicates the parameter S₁₁ (in decibels); dashed lines and solid lines are simulation results for an antenna apparatus 10 without stubs 18-1 and 18-2 and for an antenna apparatus 10 with stubs 18-1 and 18-2, respectively.

As illustrated in FIG. 3, simulation results were obtained indicating that for frequencies from “1.7 GHz” to “2.5 GHz”, the parameter S₁₁ was lower for the antenna apparatus 10 with stubs 18-1 and 18-2 than for the antenna apparatus 10 without stubs 18-1 and 18-2. Hence compared with the case without stubs 18-1 and 18-2, the antenna apparatus 10 having the stubs 18-1 and 18-2 has lower reflected voltage, and the parameter S₁₁ can be improved, over this frequency range. From these simulation results, when for example the frequency of transmitted or received radio signals is between “1.5 GHz” and “2.5 GHz”, with respect to matching, characteristics for the antenna apparatus 10 equal to or greater than a specific value can be obtained.

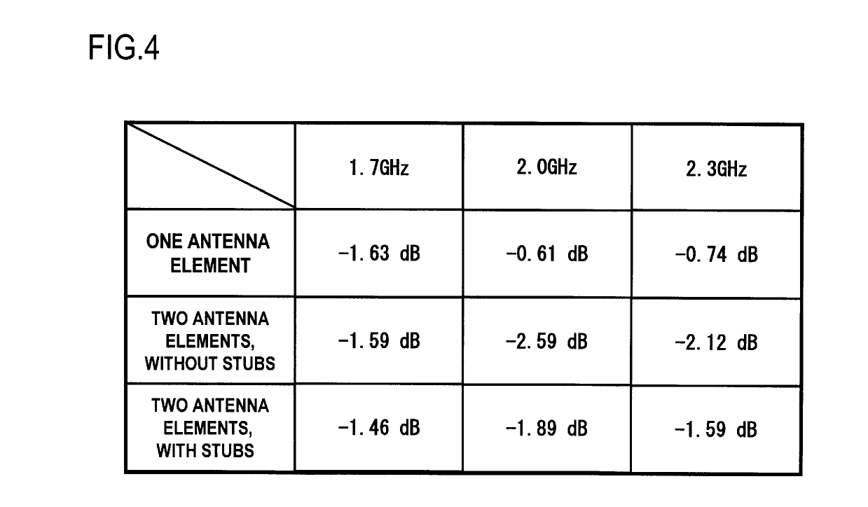

FIG. 4 illustrates an example of simulation results for antenna efficiency. Antenna efficiency represents for example the ratio of radiation power to the power applied to the antenna elements 14-1 and 14-2. For example, simulation is performed in which, when an AC voltage is applied to the first feed point 16-1, the frequency of the applied AC voltage is varied, and the power radiated into space in the first antenna element 14-1 is measured or otherwise determined. Simulations were performed, in cases in which there is a “single” “antenna element”, in which there are “two antenna elements” “without stubs”, and in which there are “two antenna elements” “with stubs”, with the frequency of the AC voltage varied between “1.7 GHz”, “2.0 GHz”, and “2.3 GHz”.

As illustrated in FIG. 4, simulation results were obtained indicating that the antenna efficiency is higher for an antenna apparatus 10 with stubs 18-1 and 18-2 than an antenna apparatus 10 without stubs 18-1 and 18-2 at each frequency, including the frequency “1.7 GHz”. From these simulation results, the antenna efficiency of this antenna apparatus 10 can be raised, compared with that of an antenna apparatus 10 without stubs 18-1 and 18-2, when the frequency of radio signals transmitted and received by the antenna elements 14-1 and 14-2 is for example “1.7 GHz”.

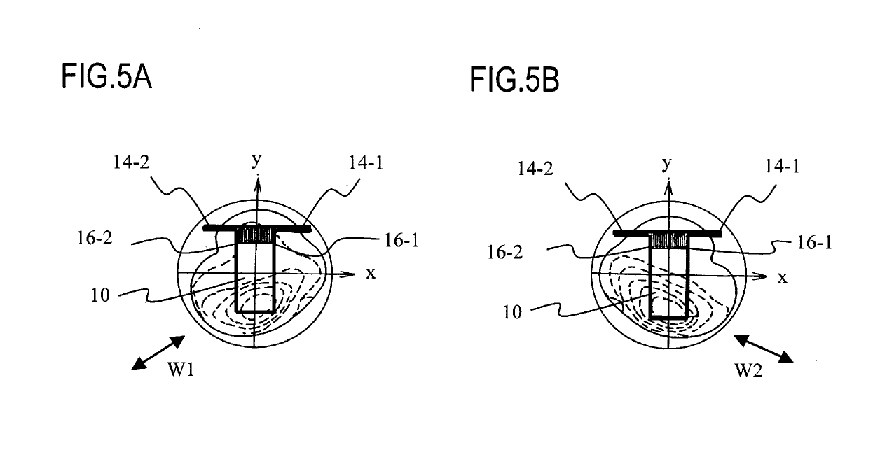

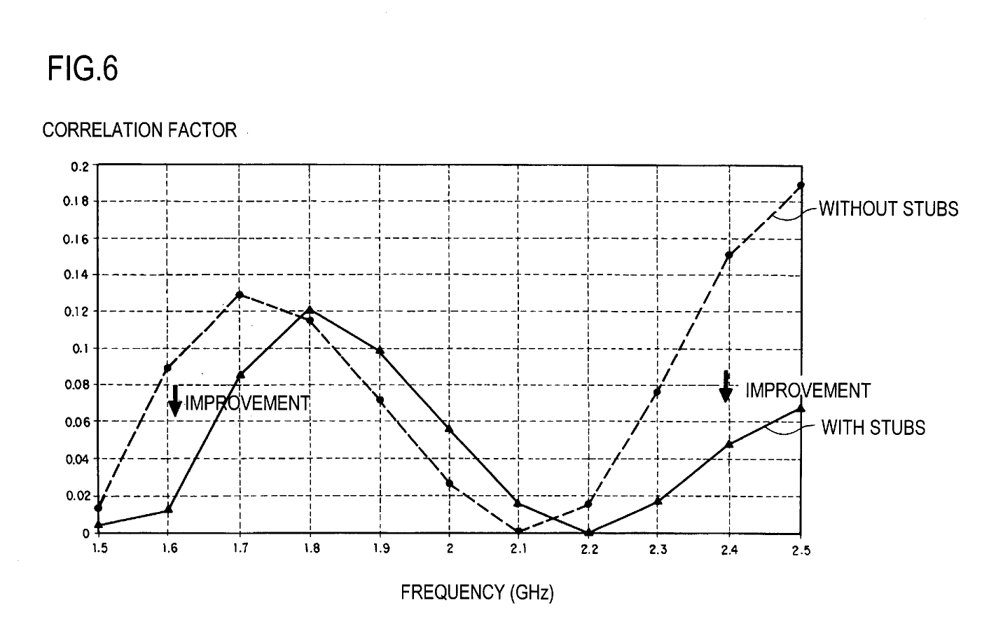

FIG. 5A and FIG. 5B illustrate radiation patterns, and FIG. 6 illustrates an example of simulation results for correlation factors.

The radiation pattern illustrated in FIG. 5A illustrates, for example, the directional distribution when an AC voltage is applied at frequency “2.2 GHz” to the first feed point 16-1 in the antenna apparatus 10, and no voltage is applied to the second feed point 16-2. Further, the radiation pattern illustrated in FIG. 5B illustrates, for example, the directional distribution when an AC voltage is applied at frequency “2.2 GHz” to the second feed point 16-2, and no voltage is applied to the first feed point 16-1.

When an AC voltage is applied to the first feed point 16-1, a portion with higher power compared with elsewhere is distributed in the W1 direction, which is in the y axis second quadrant, as illustrated in FIG. 5A. On the other hand, when an AC voltage is applied to the second feed point 16-2, a portion with higher power compared with elsewhere is distributed in the W2 direction, which is in the y axis second quadrant, as illustrated in FIG. 5B.

In this way, simulation results were obtained indicating that the two radiation patterns are directed in opposite directions (the W1 direction and the W2 direction).

FIG. 6 illustrates simulation results for the correlation factors, based on radiation patterns and similar when the frequency of the applied AC voltage was varied. The correlation factors are an index indicating the extent of coincidence between, for example, the radiation pattern when feeding from the first feed point 16-1 (for example, FIG. 5A) and the radiation pattern when feeding from the second feed point 16-2 (for example, FIG. 5B). In FIG. 6, the horizontal axis indicates the frequency and the vertical axis indicates the correlation factors; the solid line and the dashed line are simulation results when there are stubs 18-1 and 18-2, and when there are no stubs 18-1 and 18-2, respectively.

As illustrated in FIG. 6, simulation results were obtained indicating that, compared with the case of no stubs 18-1 and 18-2, the correlation factors of the antenna apparatus 10 with stubs 18-1 and 18-2 is low from “1.5 GHz” to “1.7 GHz”, from “2.2 GHz” to “2.5 GHz”, and similar. Hence improved simulation results for this antenna apparatus 10 could be obtained for the correlation factors as well, compared with an antenna apparatus without stubs 18-1 and 18-2, over these frequency ranges. From these simulation results, characteristics relating to correlation equal to or greater than a specific value can be obtained for this antenna apparatus 10 for frequencies of the radio signals transmitted or received from “1.5 GHz” to “1.7 GHz” and for “2.2 GHz” to “2.5 GHz”.

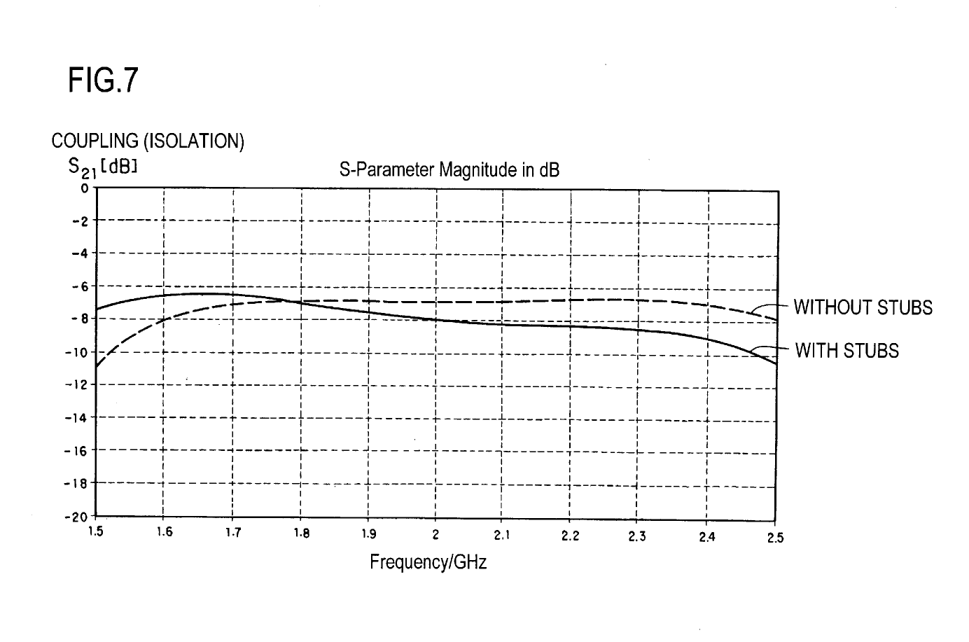

FIG. 7 illustrates simulation results for the parameter S₂₁ (or “coupling” or “isolation”) among the S parameters. In these simulations, in for example the antenna apparatus 10 illustrated in FIG. 1 and similar, an AC voltage is applied from the first feed point 16-1 to the first antenna element 14-1, and the frequency of the voltage is varied. At this time, this simulation simulates the parameter S₂₁ by measuring or otherwise determining this voltage and the voltage output from the second feed point 16-2. The voltage supply is for example between the ground pattern 15 and the first feed point 16-1. In FIG. 7, the horizontal axis indicates the frequency and the vertical axis indicates S₂₁ (in decibels). In the figure, the dashed line and the solid line indicate simulation results for an antenna apparatus 10 with stubs 18-1 and 18-2 and for an antenna apparatus 10 without stubs 18-1 and 18-2, respectively.

As illustrated in FIG. 7, the parameter S₂₁ of the antenna apparatus 10 with stubs 18-1 and 18-2, and the parameter S₂₁ of the antenna apparatus 10 without stubs 18-1 and 18-2, both remain at lower numerical values than a reference threshold (for example, “−6 dB”). This reference threshold indicates for example the maximum parameter S₂₁ which can be allowed with respect to coupling of the antenna elements 14-1 and 14-2. As illustrated in FIG. 7, the parameter S₂₁ of the antenna apparatus 10 with stubs 18-1 and 18-2 remains equal to or below this reference threshold for frequencies from “1.5 GHz” to “2.5 GHz”.

From these simulation results, characteristics, for example, relating to coupling equal to or greater than a specific value can be obtained for this antenna apparatus 10 for frequencies of the radio signals transmitted and received by the antenna elements 14-1 and 14-2 from “1.5 GHz” to “2.5 GHz”.

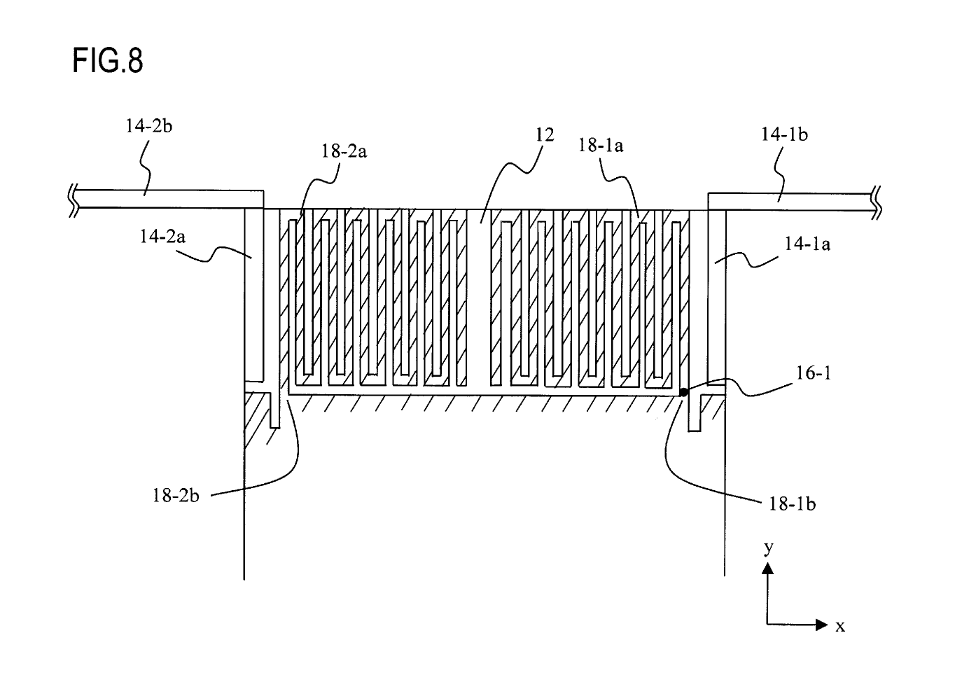

Simulation results for the stubs 18-1 and 18-2 illustrated in FIG. 1 and similar are further explained below. FIG. 8 through FIG. 11B illustrate examples and similar of simulation results.

FIG. 8 is a partial enlarged view of an antenna apparatus 10 for simulation. In order to simulate the characteristics of the stubs 18-1 and 18-2, the first feed point 16-1 is arranged at the first connection unit 18-1b.

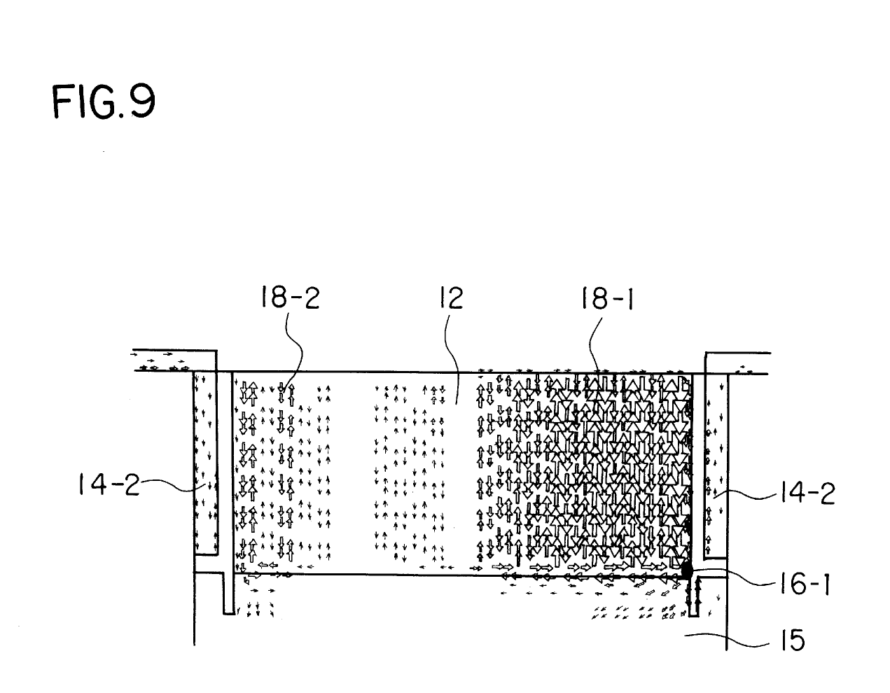

FIG. 9 illustrates an example of current distribution when an AC voltage is applied from the first feed point 16-1. The figure illustrates an example of simulation results when the frequency of the AC voltage is “1.4 GHz”; the sizes and thicknesses of arrows indicate the current magnitude.

As illustrated in FIG. 9, because feeding is from the first feed point 16-1, a large current flows at the first stub 18-1 compared with the second stub 18-2 and similar. In this antenna apparatus 10, by shaping the stubs 18-1 and 18-2 as illustrated in FIG. 1 and similar, simulation results were obtained in which a large current flows at an AC voltage frequency of “1.4 GHz” compared with at other frequencies. Next, the reason for the flowing of a large current at frequency “1.4 GHz” is explained.

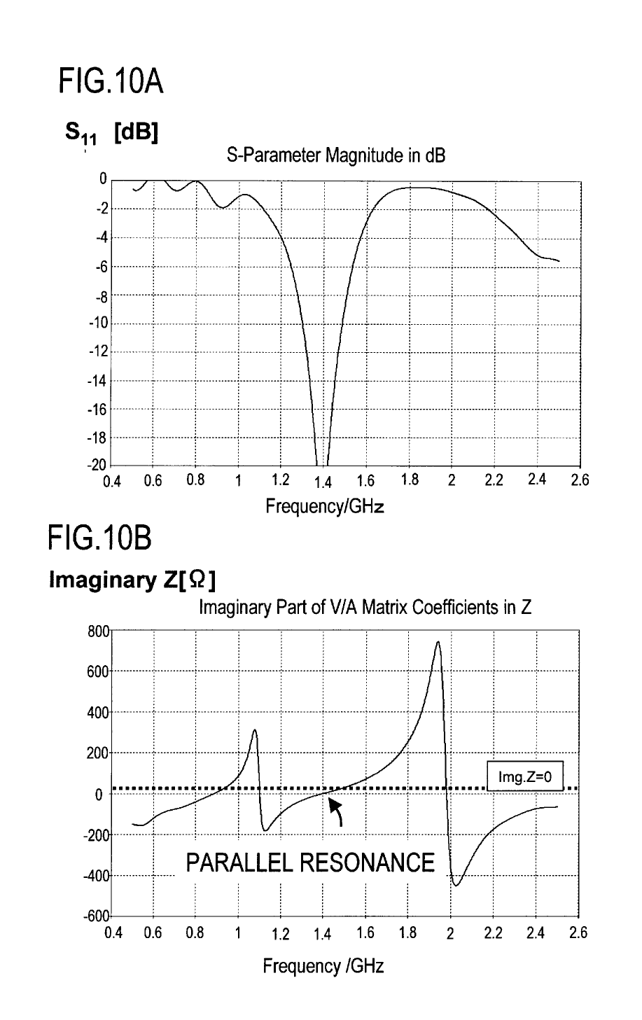

FIG. 10A illustrates simulation results for the parameter S₁₁ in the first antenna element 14-1 in the antenna apparatus 10 illustrated in FIG. 8, when an AC voltage is fed from the first feed point 16-1. Further, FIG. 10B illustrates simulation results for the imaginary part of the combined impedance (reactance) of the stubs 18-1 and 18-2. FIG. 10A and FIG. 10B are both simulation results when the frequency of the fed AC voltage is varied from “0.5 GHz” to “2.5 GHz”.

As illustrated in FIG. 10A, simulation results were obtained in which the parameter S₁₁ is much lower at the frequency “1.4 GHz” compared with at other frequencies. Further, as illustrated in FIG. 10B, simulation results were obtained in which the reactance was “0” at frequency “1.4 GHz”.

From this, by making the stub shape as in FIG. 2 and FIG. 8, the stubs 18-1 and 18-2 enter a parallel resonance state at frequency “1.4 GHz”. Because of this state, simulation results could be obtained in which a large current equal to or greater than a specific value flows when the frequency of the AC voltage fed from the first feed point 16-1 is “1.4 GHz”, as illustrated in FIG. 9.

As explained above, relating to matching (parameter S₁₁), improved simulation results were obtained for this antenna apparatus 10 (for example, FIG. 3 and similar); next, the reason for this improvement is explained.

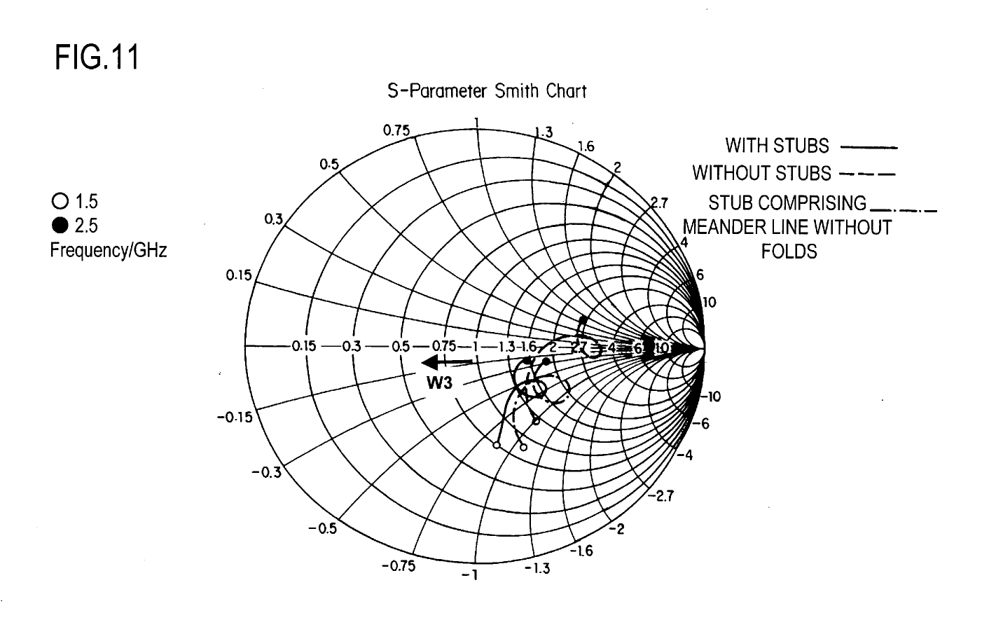

FIG. 11 is a Smith chart illustrating an example of impedance changes in each of an antenna apparatus 10 with stubs 18-1 and 18-2, an antenna apparatus 10 without stubs 18-1 and 18-2, and an antenna apparatus 10 having a meander line without folds.

As the antenna apparatus 10 having stubs 18-1 and 18-2 which was to be simulated, for example the antenna apparatus 10 of FIG. 8 was selected. This selection was made in order to confirm the characteristics of the stubs 18-1 and 18-2 similarly to the above-described examples.

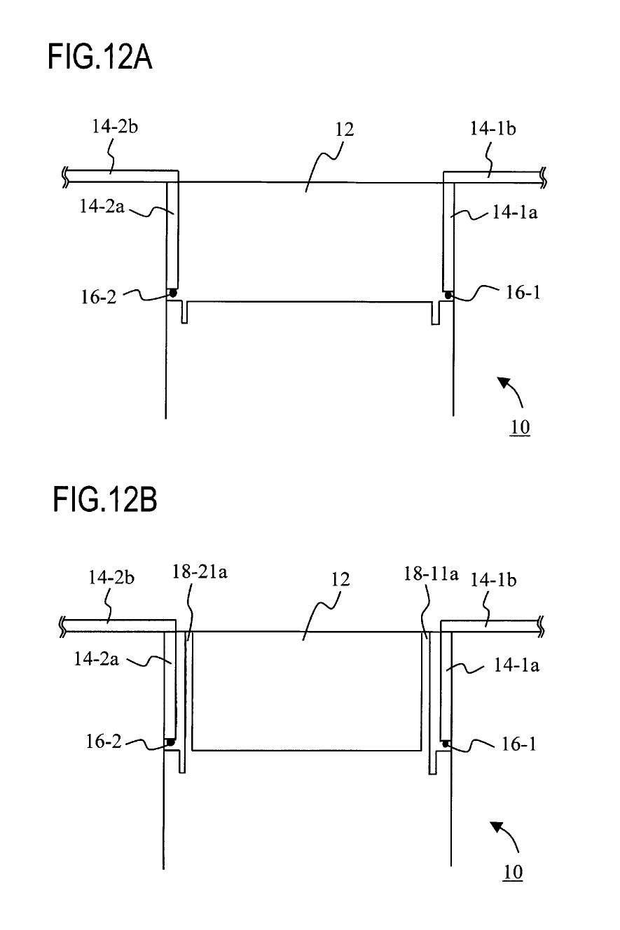

Further, FIG. 12A is a configuration example of an antenna apparatus 10 without stubs 18-1 and 18-2 which is to be simulated, and FIG. 12B is a configuration example of an antenna apparatus 10 having a meander line without folds which is to be simulated. As illustrated in FIG. 12B, an antenna apparatus 10 having a meander line without folds has, for example, a structure with a straight-line shape in which the meander units 18-11a and 18-21a closest to the antenna elements 14-1 and 14-2 are not folded.

In these simulations, for example an AC voltage is applied from the first feed point 16-1 of the antenna apparatus 10, and the change in impedance of the first antenna element 14-1 when the frequency of the AC voltage is varied from “1.5 GHz” to “2.5 GHz” is measured. The horizontal axis in FIG. 11 indicates the real part of the impedance (or the pure resistance), the upper half of the vertical axis indicates the inductive region, and the lower half indicates the capacitive region. In FIG. 11, the solid line and the dashed line are simulation results for the antenna apparatus 10 with stubs 18-1 and 18-2 (for example, FIG. 8) and for the antenna apparatus 10 without stubs 18-1 and 18-2 (for example, FIG. 12A), respectively. The dot-dash line indicates simulation results for the antenna apparatus 10 having a meander line without folds (for example, FIG. 12B).

As illustrated in FIG. 11, the simulation results for the antenna apparatus 10 without stubs 18-1 and 18-2 (“no stubs”) indicate that the pure resistance remains at the position farthest from point “1” compared with the others. Next, the pure resistance for the antenna apparatus 10 having a meander line without folds (“stub having a meander line without folds”) remains at a position far from point “1”. The simulation results for the antenna apparatus 10 with stubs 18-1 and 18-2 (“with stubs”) indicate that the pure resistance is closest to “1”.

From these simulation results, the pure resistance for the antenna apparatus 10 with stubs 18-1 and 18-2 is closest to “1” compared with others, so that the best matching is possible. Hence as illustrated in FIG. 3, simulation results can be obtained for the antenna apparatus 10 having two stubs 18-1 and 18-2 with lower reflection coefficient and lower parameter S₁₁ than an antenna apparatus without stubs 18-1 and 18-2.

As illustrated in FIG. 2 and similar, it is known that by providing a metal surface in proximity to the antenna elements 14-1 and 14-2 (for example, within a distance href), the radiation resistance and similar assume low values equal to or less than a specific value, and the graph on a Smith chart moves in the W3 direction in FIG. 11. In this antenna apparatus 10 also, the meander units 18-1a and 18-2a of the stubs 18-1 and 18-2 are installed in proximity to the antenna elements 14-1 and 14-2 (within threshold value href), so that the radiation resistance is a low value equal to or less than a specific value, and matching and similar are also improved.

In this way, the antenna apparatus 10 of this first example is provided with first and second stubs 18-1 and 18-2 between the antenna elements 14-1 and 14-2, and with the first stub 18-1 and first feed point 16-1, and the first antenna element 14-1 as one set, has two sets. By means of such a configuration, characteristics equal to or above specific values for matching, coupling, and correlation factors can be obtained for antenna apparatus 10 when the frequency of radio signals transmitted or received is “1.7 GHz”, or is from “2.2 GHz” to “2.5 GHz”.

Further, because this antenna apparatus 10 does not have cutouts, slits or similar of size equal to or greater than a specific value as indicated in Japanese Laid-open Patent Publication No. 2007-13643 or in Japanese Laid-open Patent Publication No. 2007-243455, greater compactness or reduced space usage can be achieved for this antenna apparatus 10. Moreover, the stubs 18-1 and 18-2 are not directly connected to the antenna elements 14-1 and 14-2, but one end thereof is directly connected to the ground pattern 15. Hence a separate matching circuit or similar need not be provided, without changing the characteristics of the antenna elements 14-1 and 14-2. Hence this antenna apparatus 10 can attain cost reductions and similar.

### Second Example

Next a second example is explained. In the first example, an explanation was given in which the lengths (or heights) in the y-axis direction of the meander units 18-1a and 18-2a in the stubs 18-1 and 18-2 were the same. For example, the lengths may be made short compared with others at places closest to the fixed units 14-1a and 14-2a of the antenna elements 14-1 and 14-2, and may be made longer in moving from the antenna elements 14-1 and 14-2. By this means, the length from the connection units 18-1b and 18-2b of the stubs 18-1 and 18-2 to the tip units 18-1c and 18-2c can be shortened.

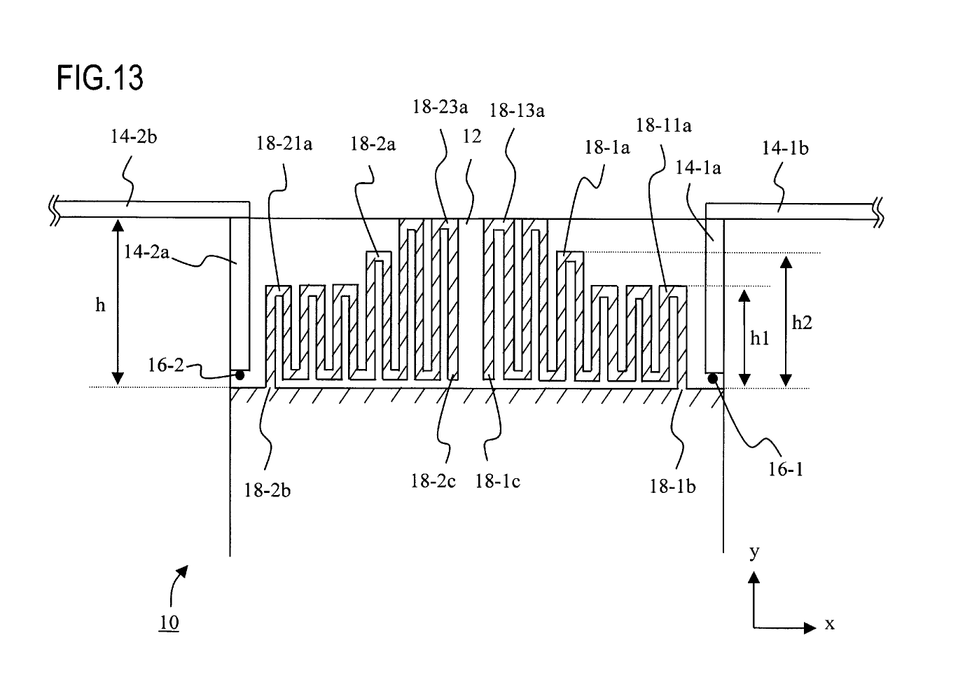

FIG. 13 is a partial enlarged view of this antenna apparatus 10. In the example illustrated in FIG. 13, the height in the y-axis direction of the meander units 18-11a and 18-21a closest to the fixed units 14-1a and 14-2a of the antenna elements 14-1 and 14-2 is “h1”, and the height in the y-axis direction of the meander units 18-1a and 18-2a near the middle is “h2” (h1<h2). The height of the meander units 18-13a and 18-23a farthest from the fixed units 14-1a and 14-2a is “h” (h2<h).

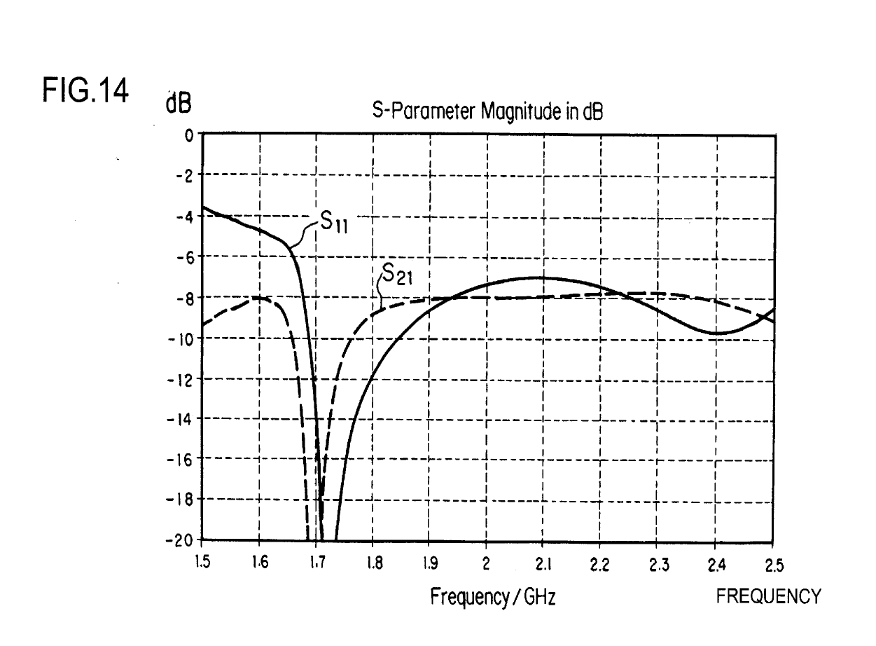

Next, simulation results for an antenna apparatus 10 configured in this way are explained. FIG. 14 illustrates an example of simulation results for the parameters S₁₁ (or “matching”) and S₂₁ (or “coupling”). Similarly to the first example, FIG. 14 describes simulations in which an AC voltage is fed from the first feed point 16-1 for example, and the radiation voltage from the first feed point 16-1 is measured, or the output voltage from the second feed point 16-2 is measured, or similar. In FIG. 14, the solid and dashed lines indicate simulations of the parameter S₁₁ and of the parameter S₂₁ respectively.

As illustrated in FIG. 14, the two parameters S₁₁ and S₂₁ both remain at low numerical values equal to or less than the reference threshold “−6 dB”, similarly to the first example, at frequencies of “1.7 GHz” or higher. Further, simulation results were obtained in which the two parameters S₁₁ and S₂₁ were much lower at the frequency “1.7 GHz” than at other frequencies.

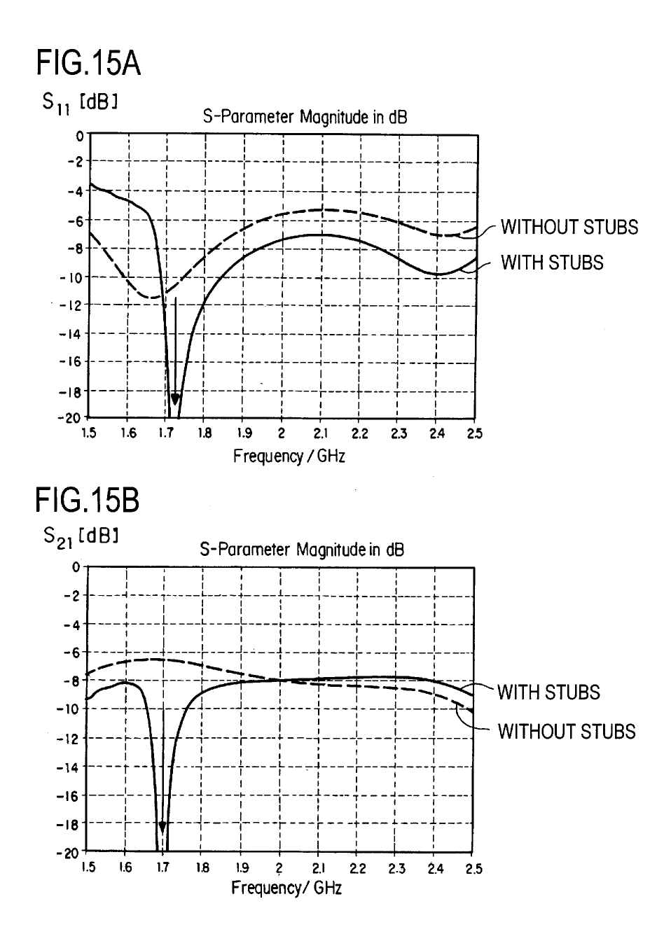

FIG. 15A illustrates simulation results for parameter S₁₁, compared with an antenna apparatus 10 without stubs 18-1 and 18-2 (for example, FIG. 12A). Further, FIG. 15B illustrates simulation results for parameter S₂₁, compared with an antenna apparatus 10 without stubs 18-1 and 18-2. In FIG. 15A and FIG. 15B, the graphs indicated as “with stubs” are the same as the respective graphs “S11” and “S21” in FIG. 14.

As illustrated in FIG. 15A, simulation results were obtained for this antenna apparatus 10 (for example, FIG. 13) indicating, for the parameter S₁₁, a low value compared with an antenna apparatus without stubs 18-1 and 18-2 at frequencies equal to or above “1.7 GHz”. Further, as illustrated in FIG. 15B, simulation results for the parameter S₂₁ were obtained indicating that the value at frequency “1.7 GHz” is much lower for an antenna apparatus 10 with stubs 18-1 and 18-2 than for an antenna apparatus 10 without stubs 18-1 and 18-2.

From these simulation results, characteristics can be obtained for matching and coupling of the antenna apparatus 10 of the second example which, when the frequency of radio signals transmitted or received is “1.7 GHz” or higher, are on average a specific value, or are equal to or greater than a specific value.

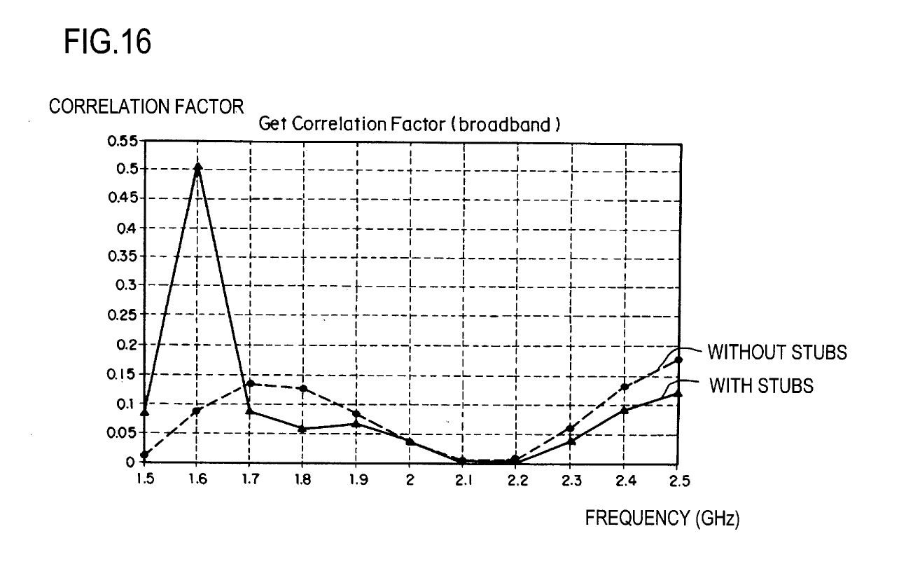

FIG. 16 illustrates an example of simulation results for correlation factors. Similarly to the first example, FIG. 16 illustrates simulation results for the degree of coincidence between the radiation pattern when feeding is performed from the first feed point 16-1 and the radiation pattern when feeding is performed from the second feed point 16-2, when the frequency of the AC current fed was varied.

As illustrated in FIG. 16, results were obtained indicating that the correlation factors for the antenna apparatus 10 of the second example is low, compared with an antenna apparatus 10 without stubs 18-1 and 18-2, at frequencies of “1.7 GHz” or higher.

With respect to antenna efficiency also, similarly to the first example, simulation results indicated that at frequency “1.7 GHz” a numerical value of “−1.45 dB” was obtained. In the case of “two antenna elements with no stubs” of FIG. 4, at frequency “1.7 GHz” the value was “−1.59 dB”; compared with this, simulation results indicated a high antenna efficiency for this antenna apparatus 10. Simulation results obtained for the antenna efficiency of the antenna apparatus 10 of this second example were further improved over the antenna apparatus 10 of the first example.

From simulation results for the correlation factors and antenna efficiency, characteristics for the coupling and antenna efficiency of the antenna apparatus 10 of the second example equal to or greater than a specific value could be obtained when the frequency of radio signals transmitted or received was “1.7 GHz” or above.

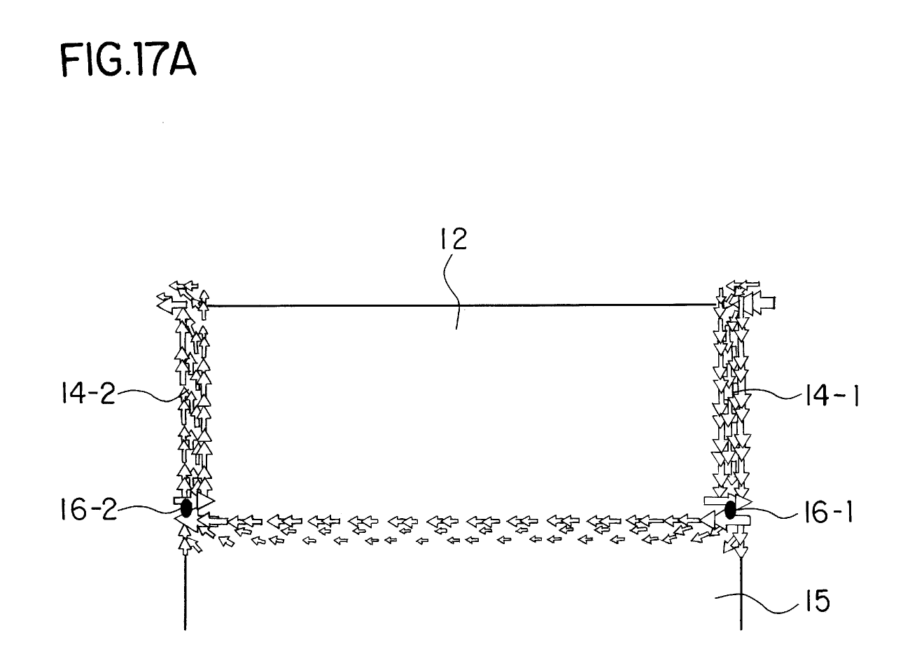

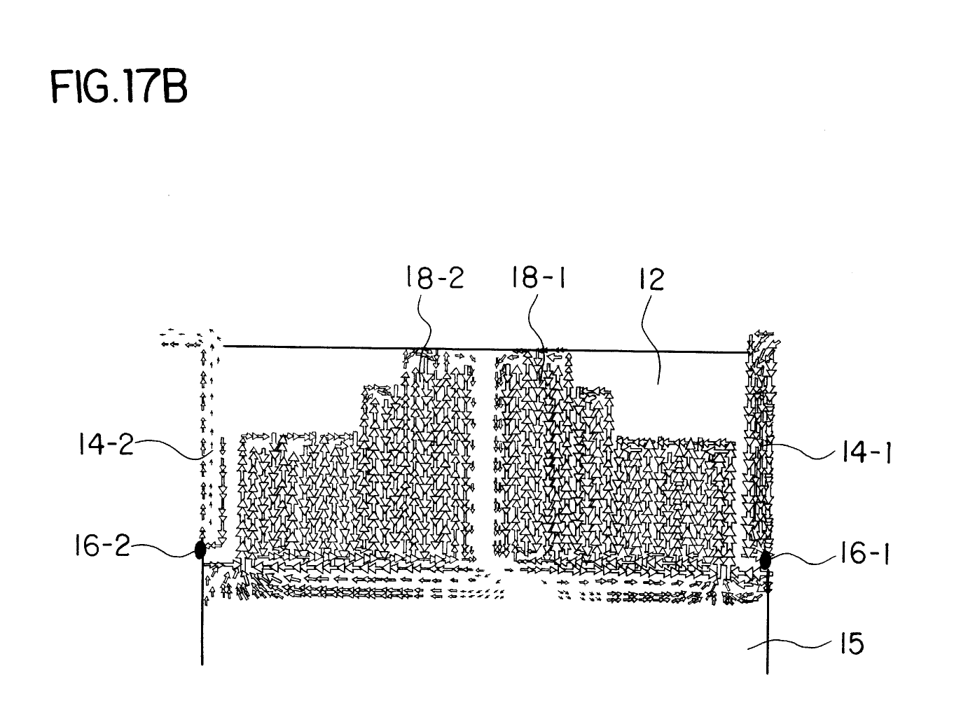

Next, the reason for this improvement in the antenna efficiency and coupling is explained. FIG. 17A and FIG. 17B each illustrate simulation results for current distribution when the frequency of the AC voltage fed is “1.7 GHz”. FIG. 17A is the current distribution for an antenna apparatus 10 without stubs 18-1 and 18-2, and FIG. 17B is the current distribution for the antenna apparatus 10 of this second example. These simulations, similar to those of the first example (FIG. 9), are for a case in which feeding is performed from the first feed point 16-1, and no feeding from the second feed point 16-2 is performed. In both FIG. 17A and FIG. 17B, the magnitudes of arrows indicate the strength of the current.

Focusing on the second antenna element 14-2 which is not being fed, a larger current is flowing in the antenna apparatus 10 without stubs 18-1 and 18-2 (FIG. 17A) than in the antenna apparatus 10 with stubs 18-1 and 18-2 (FIG. 17B). Due to this large current, coupling of the second antenna element 14-2 and the first antenna element 14-1 of the antenna apparatus 10 without stubs 18-1 and 18-2 becomes equal to or larger than a specific value. Further, due to this large current, the antenna efficiency of the antenna apparatus 10 without stubs 18-1 and 18-2 deteriorates to be equal to or less than a specific value, as electric power (or energy) equal to or greater than a specific value is consumed at the second feed point 16-2.

On the other hand, in the antenna apparatus 10 with stubs 18-1 and 18-2 (FIG. 17B), a large current equal to or greater than a specific value flows in the stubs 18-1 and 18-2, and in the second antenna element 14-2 not being fed, a small current compared with that with stubs 18-1 and 18-2 flows. Due to this small current, coupling between the first and second antenna elements 14-1 and 14-2 in the antenna apparatus 10 with stubs 18-1 and 18-2 weakens to be equal to or less than a specific value. Further, due to this small current, in the antenna apparatus 10 with stubs 18-1 and 18-2 the electric power consumed at the second feed point 16-2 becomes equal to or less than a specific value, and the antenna efficiency is improved to be equal to or greater than a specific value.

From the above, characteristics equal to or greater than a specific value for matching, coupling, and correlation factors can be obtained for the antenna apparatus 10 of this second example when the frequency of radio signals transmitted or received is for example from “1.7 GHz” to “2.5 GHz”. Further, similarly to the first example, costs can be reduced for the antenna apparatus 10 of this second example, without providing a separate matching circuit or similar to obtain satisfactory characteristics for the antenna elements 14-1 and 14-2. Moreover, because the antenna apparatus 10 of this second example does not have cutouts, slits or similar of size equal to or greater than a specific value as indicated in Japanese Laid-open Patent Publication No. 2007-13643 or in Japanese Laid-open Patent Publication No. 2007-243455, greater compactness or reduced space usage can be achieved.

As illustrated in FIG. 14, FIG. 17 and similar, when the frequency of the fed AC voltage is “1.7 GHz”, the stubs 18-1 and 18-2 are in a resonant state. Hence as illustrated in FIG. 17B, the current flowing in the stubs 18-1 and 18-2 is a large current equal to or greater than a specific value. The length of the stubs 18-1 and 18-2 of the antenna apparatus 10 in the second example is shorter than the length of the stubs 18-1 and 18-2 in the first example. In this way, by adjusting the lengths of the stubs 18-1 and 18-2, the resonance frequency could be adjusted from the “1.4 GHz” of the first example to the “1.7 GHz” of the second example. From this, by adjusting the length of the stubs 18-1 and 18-2, it is also possible to change the frequency band in which characteristics relating to coupling, correlation factors and similar which are equal to or greater than a specific value can be obtained.

### Third Example

Next, a third example is explained. In the antenna apparatus 10 of the second example, the length in the y-axis direction of the meander units 18-1a and 18-2a was made longer with increasing distance from the antenna elements 14-1 and 14-2. For example, the length in the y-axis direction of the meander units 18-11a and 18-21a closest to the antenna elements 14-1 and 14-2 can be made longer than the length of the meander units 18-12a and 18-22a with the shortest length in the y-axis direction.

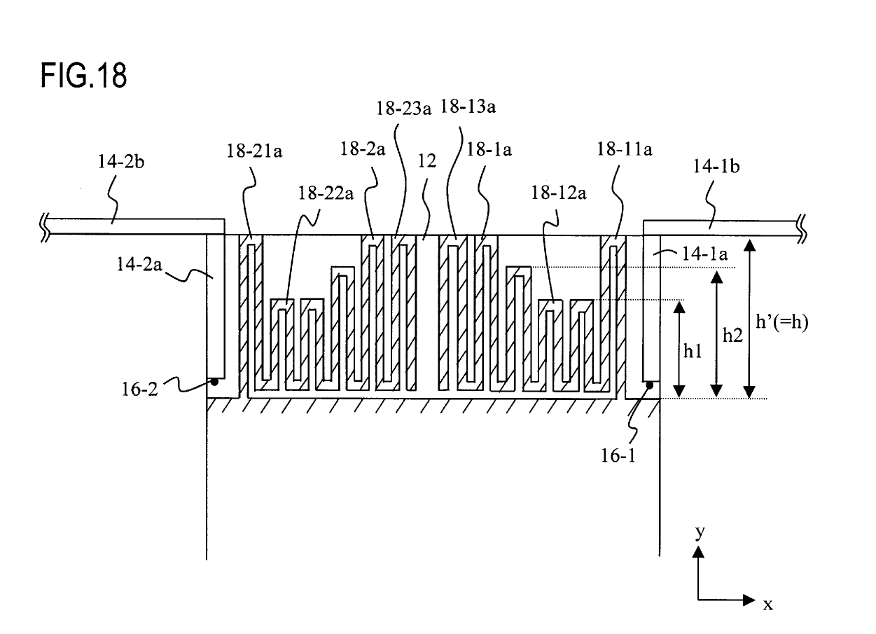

FIG. 18 is a partial enlarged view of the antenna apparatus 10 of the third example. As illustrated in FIG. 18, of the meander units 18-1a and 18-2a, the length in the y-axis direction of the meander units 18-11a and 18-21a closest to the antenna elements 14-1 and 14-2 is made “h′”. At this time, if the length in the y-axis direction of the meander units 18-12a and 18-22a which have the shortest length in the y-axis direction is “h1”, then the meander units 18-11a and 18-21a are installed such that h′>h1. In the example of FIG. 18, the length h′ is the same length as the length “h” of the stubs 18-13a and 18-23a with the longest length in the y-axis direction. Other than the meander units 18-11a and 18-21a closest to the antenna elements 14-1 and 14-2, meander units are arranged such that the length in the y-axis direction increases with increasing distance from the antenna elements 14-1 and 14-2.

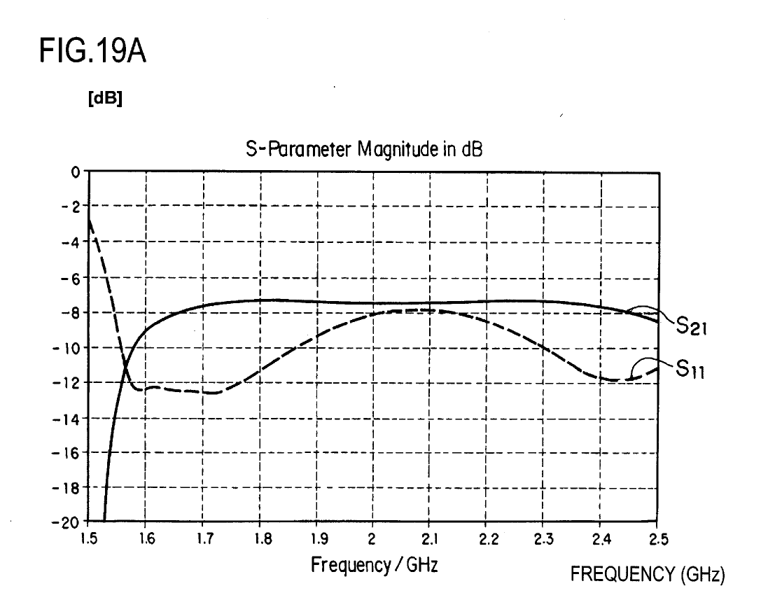

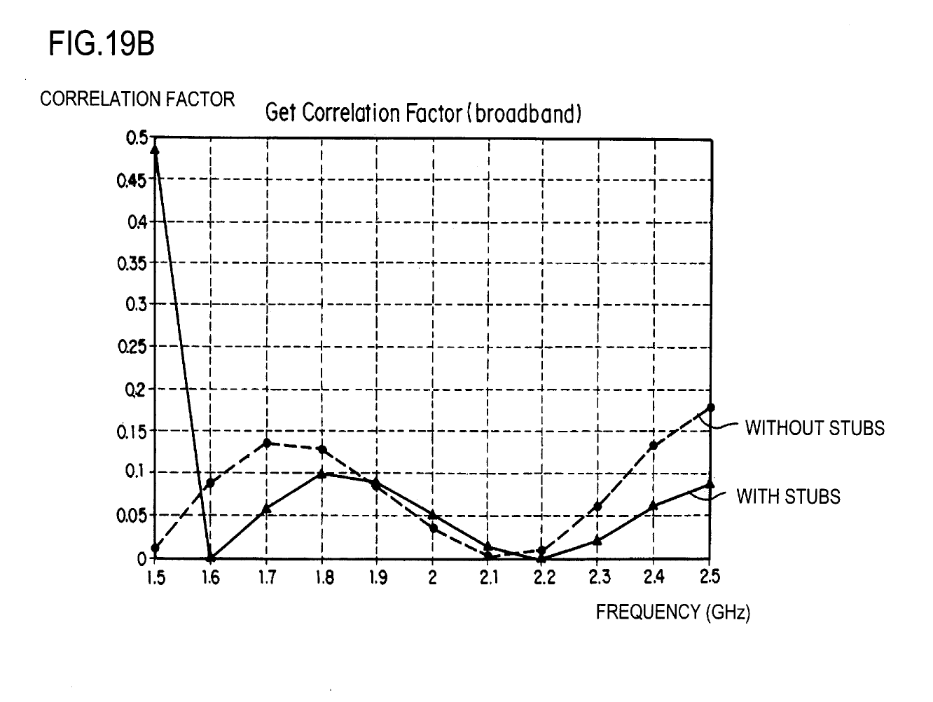

Simulation results for the antenna apparatus 10 in this third example are explained. FIG. 19A illustrates examples of simulation results for the parameter S₁₁ (matching) and the parameter S₂₁ (coupling). For example, similarly to the first example and similar, simulations were performed in which an AC voltage with different frequencies was fed to the first feed point 16-1, and the reflected voltage of the first feed point 16-1 or the output voltage from the second feed point 16-2 was measured or otherwise determined.

As illustrated in FIG. 19A, simulation results were obtained in which the two parameters S₁₁ and S₂₁ were less than a reference threshold “−6 dB” over frequencies from “1.6 GHz” to “2.5 GHz”.

FIG. 19B illustrates an example of simulation results for the correlation factors. Similarly to the first example and similar, simulations were performed based on the radiation pattern when feeding to the first feed point 16-1 and the radiation pattern when feeding to the second feed point 16-2.

As illustrated in FIG. 19B, the correlation factors of the antenna apparatus 10 with stubs 18-1 and 18-2, illustrated in FIG. 18, also remains at a lower numerical value than an antenna apparatus without stubs 18-1 and 18-2 at frequencies from “1.6 GHz” to “2.5 GHz”.

From the above simulation results, characters for matching, coupling, and correlation factors of the antenna apparatus 10 of the third example equal to or greater than a specific value can be obtained when the frequency of radio signals transmitted or received is from “1.6 GHz” to “2.5 GHz”.

Characteristics equal to or above a specific value could be obtained for the antenna apparatus 10 of the second example at frequencies of “1.7 GHz” or above; but in the antenna apparatus 10 of this third example, by further adjusting the lengths of the stubs 18-1 and 18-2, characteristics equal to or greater than a specific value can be obtained for radio signals in a still broader band.

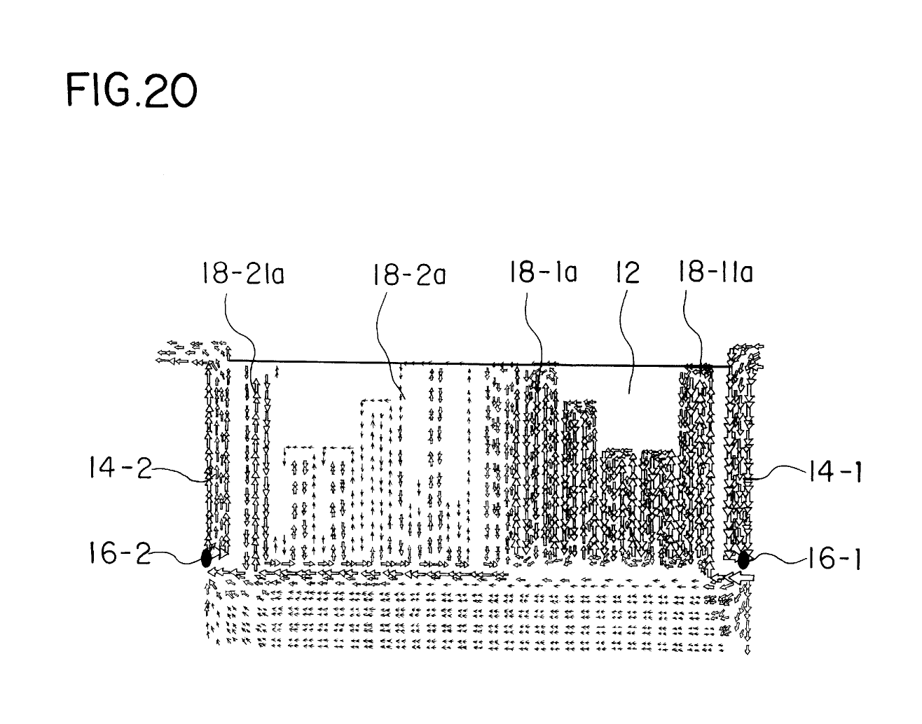

FIG. 20 illustrates an example of simulation results for current distribution in this antenna apparatus 10. This simulation is also an example of current distribution for a case in which, similarly to the second example, an AC voltage having a frequency of “1.7 GHz” is applied from the first feed point 16-1.

Upon comparison with FIG. 17A illustrating an example of simulation of current distribution without stubs 18-1 and 18-2, in the example of FIG. 20 a small current is flowing in the second antenna element 14-2 on the side not being fed. Similarly to the second example, because of this small current, coupling between the two antenna elements 14-1 and 14-2 is less than a specific value, and the antenna efficiency is also improved to be equal to or greater than a specific value.

The antenna efficiency of the antenna apparatus 10 in this third example is “−1.29 dB”, so that a still higher numerical value than in the first example and similar was obtained.

Similarly to the first example and similar, a matching circuit for the antenna elements 14-1 and 14-2 is not provided in the antenna apparatus 10 in this third example, so that cost reductions and similar are also possible. Further, similarly to the first example and similar, because the antenna apparatus 10 of this third example does not have cutouts, slits or similar of size equal to or greater than a specific value as indicated in Japanese Laid-open Patent Publication No. 2007-13643 or in Japanese Laid-open Patent Publication No. 2007-243455, reduced space usage and greater compactness can be achieved.

### Fourth Example

Next, a fourth example is explained. The fourth example is an example of a case in which the antenna apparatus 10 of the first example or similar is loaded into or accommodated within a personal computer or other radio terminal apparatus 100.

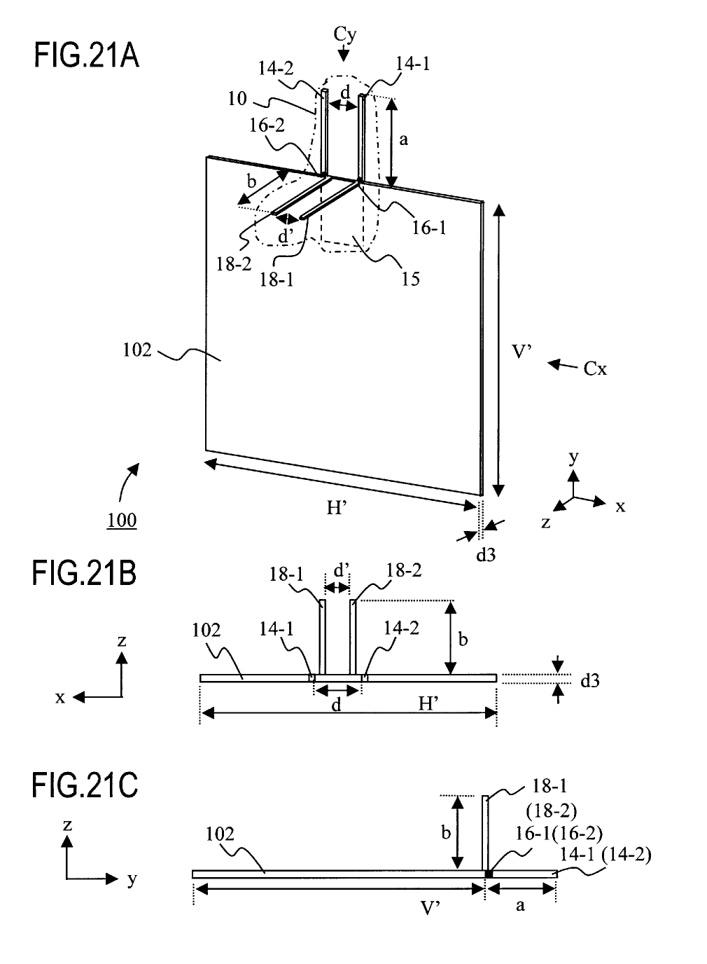

FIG. 21A is a perspective view of a case in which the antenna apparatus 10 is loaded into a radio terminal apparatus 100 or similar, FIG. 21B is a cross-sectional view as seen from the Cy direction of the radio terminal apparatus 100 illustrated in FIG. 21A, and FIG. 21C is a cross-sectional view as seen from the Cx direction of the radio terminal apparatus 100.

As illustrated in FIG. 21A and similar, the radio terminal apparatus 100 have a conductor (for example, a metal flat plate) 102, with length “H′” in the x-axis direction, length “V” in the y-axis direction, and length (thickness) “d3” in the z-axis direction. The conductor 102 forms a ground pattern for the antenna elements 14-1 and 14-2 of the antenna apparatus 10.

The length (thickness) in the z-axis direction of the antenna apparatus 10 is the same “d3” as the conductor 102, and as indicated by the dot-dash line in FIG. 21A, the antenna apparatus 10 is loaded onto a portion of the conductor 102 or similar.

When the antenna apparatus 10 is loaded into the radio terminal apparatus 10 or similar, the antenna elements 14-1 and 14-2 of the antenna apparatus 10 protrude by a distance “a” from the conductor 102. Further, the antenna elements 14-1 and 14-2 are installed at an interval a distance “d” in the x-axis direction. The antenna elements 14-1 and 14-2 also are configured from conductors.

The feed points 16-1 and 16-2 in the antenna apparatus 10 are arranged at the connection points of the antenna elements 14-1 and 14-2 respectively with the conductor 102.

Similarly to the first example and similar, the antenna apparatus 10 of this fourth example has two stubs 18-1 and 18-2; but as illustrated in FIG. 21A and similar, the stubs 18-1 and 18-2 are arranged to as to extend in the z-axis direction a distance “b” (for example, b<a) from the conductor 102. The interval “d′” between the first and second stubs 18-1 and 18-2 is for example shorter than the interval “d” between the antenna elements 14-1 and 14-2. In this way, the stubs 18-1 and 18-2 may be installed so as to extend a prescribed length within a plane (for example, within the yz plane) perpendicular to the xy plane in which the ground pattern 15 is formed.

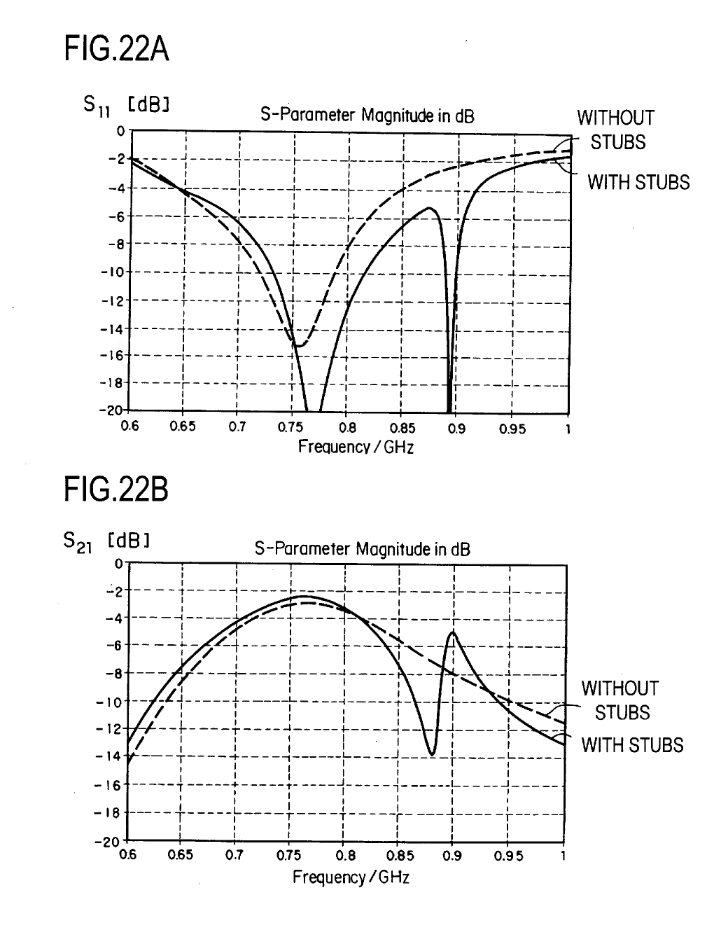

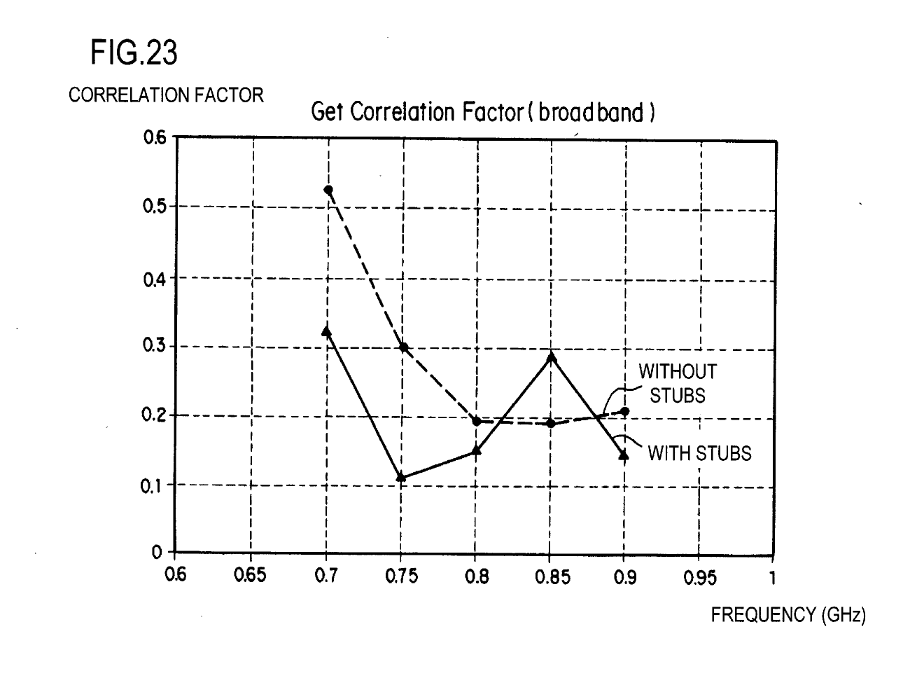

Simulation results for a radio terminal apparatus 100 including such an antenna apparatus 10 are explained below. FIG. 22A, FIG. 22B, and FIG. 23 respectively illustrate examples of simulation results for the parameter S₁₁, the parameter S₂₁, and the correlation factors.

Similarly to the first example and similar, in these simulations, for example an AC voltage with different frequencies is applied from the first feed point 16-1, and the reflected voltage from the first feed point 16-1 is measured, or the output voltage from the second feed point 16-2 is measured or otherwise determined. All simulations were performed for a radio terminal apparatus 100 including an antenna apparatus 10 with stubs 18-1 and 18-2 as illustrated in FIG. 21A and similar, and for a radio terminal apparatus 100 without stubs 18-1 and 18-2.

As illustrated in FIG. 22A, upon comparing the radio terminal apparatus 100 with stubs 18-1 and 18-2 with the radio terminal apparatus 100 without stubs 18-1 and 18-2 with respect to the parameter S₁₁, the value remains substantially the same numerical value for frequencies from “600 MHz” to “750 MHz”. However, at frequencies of “750 MHz” and above, the value is a lower numerical value for the case with stubs 18-1 and 18-2 than for the case without stubs.

Further, with respect to the parameter S₂₁, as illustrated in FIG. 22B, simulation results were obtained indicating that on average the value remains same numerical value for both the radio terminal apparatus 100 with stubs 18-1 and 18-2 and for the radio terminal apparatus without stubs 18-1 and 18-2 for frequencies from “600 MHz” to “1 GHz”.

With respect to the correlation factors, as illustrated in FIG. 23, simulation results were obtained indicating that while there is some degradation at frequency “850 MHz”, the value is lower at frequencies from “700 MHz” to “900 MHz” compared with the radio terminal apparatus 100 without stubs 18-1 and 18-2.

From the above, characteristics can be obtained for matching, coupling and correlation factors of the radio terminal apparatus 100 illustrated in FIG. 21 which, when the frequency of radio signals transmitted or received is from “700 MHz” to “900 MHz”, are on average a specific value, or are equal to or greater than a specific value.

Further, similarly to the first example, costs can be reduced for the antenna apparatus 10 of the fourth example, without providing a separate matching circuit or similar to obtain satisfactory characteristics for the antenna elements 14-1 and 14-2. Moreover, because similarly to the first example and similar the antenna apparatus 10 does not have cutouts, slits or similar of size equal to or greater than a specific value as indicated in Japanese Laid-open Patent Publication No. 2007-13643 or in Japanese Laid-open Patent Publication No. 2007-243455, reduced space usage and greater compactness can be achieved.

### Fifth Example

Next, a fifth example is explained. In the first example and similar, an antenna apparatus 10 having two stubs 18-1 and 18-2 was explained. An antenna apparatus 10 may have for example three or more stubs. This fifth example is an example of an antenna apparatus 10 which likewise has three or more stubs.

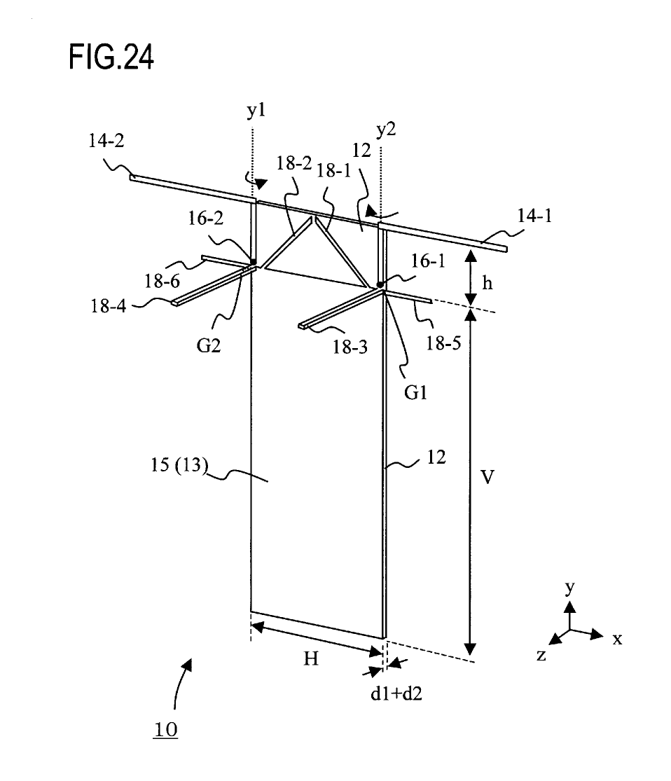

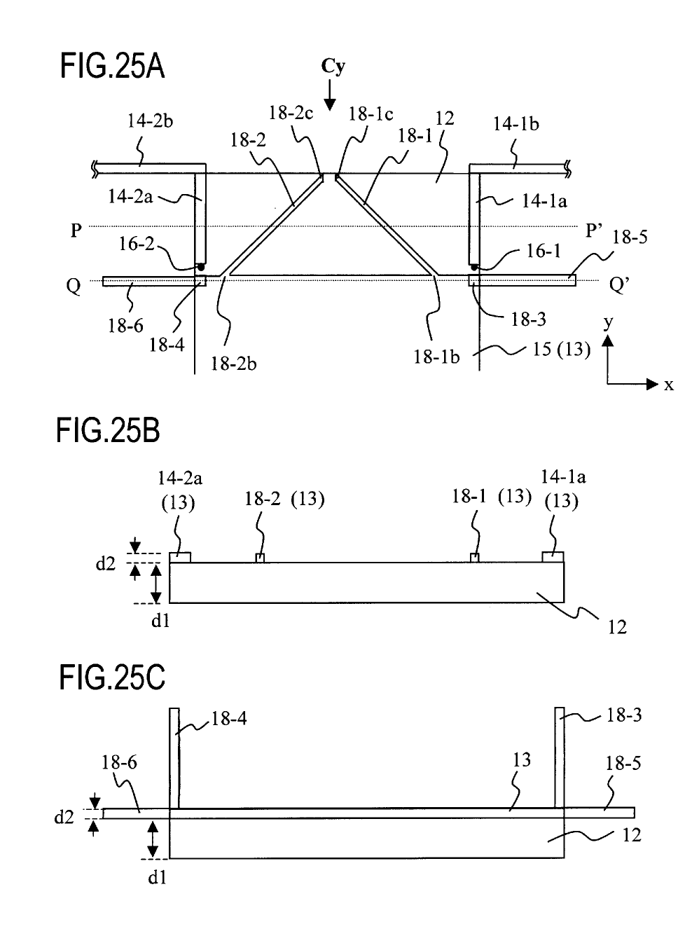

FIG. 24 is a perspective view of the antenna apparatus 10 of the fifth example; FIG. 25A is a partial enlarged view. FIG. 25B is a cross-sectional view seen from the Cy direction upon sectioning the antenna apparatus 10 at line segment P-P′ in FIG. 25A, and FIG. 25C is a cross-sectional view seen from the Cy direction upon sectioning at line segment Q-Q′.

This antenna apparatus 10 also has third through sixth stubs 18-3 through 18-6, as illustrated in FIG. 24 and similar.

As illustrated in FIG. 24 and similar, the third and fourth stubs 18-3 and 18-4 are each provided so as to extend a prescribed length in the z-axis direction from the end units G1 and G2 of the ground pattern 15 closest to the feed points 16-1 and 16-2.

Further, the fifth and sixth stubs 18-5 and 18-6 similarly are each provided so as to extend a prescribed length in the x-axis direction from the end units G1 and G2 of the ground pattern 15.

The third through sixth stubs 18-3 to 18-6, similarly to the first and second stubs 18-1 and 18-2, are also configured using for example the copper layer 13. Further, the length in the x-axis direction and the length in the y-axis direction of the third and fourth stubs 18-3 and 18-4 can for example be made the same “d2” as the copper layer 13. Further, the length in the z-axis direction of the fifth and sixth stubs 18-5 and 18-6 can also for example be made “d2”.

The first and second stubs 18-1 and 18-2 are connected to the ground pattern 15 at the connection units 18-1b and 18-2b, similarly to the first example and similar. As illustrated in FIG. 25A and similar, the first stub 18-1 extends in a straight-line shape in an oblique direction in the xy plane toward the second bent unit 14-2b of the second antenna element 14-2 with increasing distance from the first antenna element 14-1. Moreover, the second stub 18-2 extends in a straight-line shape in an oblique direction in the xy plane toward the first bent unit 14-1b of the first antenna element 14-1 with increasing distance from the second antenna element 14-2. The first and second stubs 18-1 and 18-2 are provided mutually separated at the farthest tip units 18-1c and 18-2c from the connection units 18-1b and 18-2b.

The example illustrated in FIG. 24 and similar is one example, and for example the number of stubs connected to the ground pattern 15 can be four. In this case, if the third and fourth stubs 18-3 and 18-4, or the fifth and sixth stubs 18-5 and 18-6 are deleted, such an antenna apparatus 10 can be configured. Further, by deleting the third stub 18-3 and fourth stub 18-4, and the sixth stub 18-6, an antenna apparatus 10 having a total of three stubs 18-1, 18-2, and 18-5 can be obtained. In this way, this antenna apparatus 10 can be made to have an arbitrary number of two or more stubs 18-1, 18-2, . . . .

### Sixth Example

Next, a sixth example is explained. In the sixth example, characteristics are explained when in the above-described first through fifth examples the shapes of the antenna elements 14-1 and 14-2 are made L-shapes.

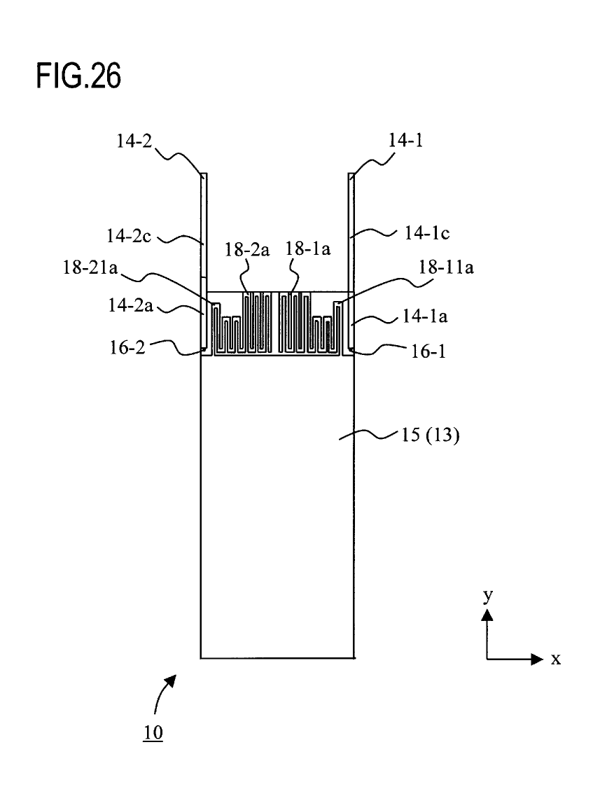

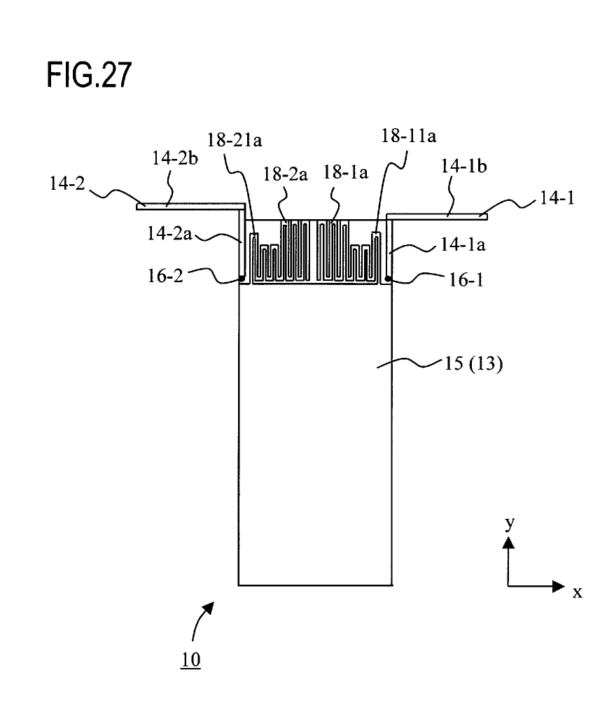

FIG. 26 and FIG. 27 illustrate examples of the configuration of the antenna apparatus 10 for simulation; of these, FIG. 26 is an example of the configuration of an antenna apparatus 10 in which the shape of the antenna elements 14-1 and 14-2 is a straight-line shape, and FIG. 27 is an example of the configuration of an antenna apparatus 10 in which the shape of the antenna elements 14-1 and 14-2 explained in the first example and similar is an L-shape.

The straight-line shape antenna elements 14-1 and 14-2 have fixed units 14-1a and 14-2a, and straight-line units 14-1c and 14-2c directed in the y-axis direction from the fixed units 14-1a and 14-2a, as illustrated in FIG. 26.

On the other hand, the L-shape antenna elements 14-1 and 14-2 have fixed units 14-1a and 14-2a, and bent units 14-1b and 14-2b, as illustrated in FIG. 27 and FIG. 2A and similar.

The shapes of the stubs 18-1 and 18-2 are both similar to those in the third example; the length in the y-axis direction of the meander units 18-11a and 18-21a closest to the fixed units 14-1a and 14-2a of the antenna elements 14-1 and 14-2 are longer than the shortest thereof. Further, the length in the y-axis direction of the meander units 18-1a and 18-2a gradually increases with increasing distance from the fixed units 14-1a and 14-2a.

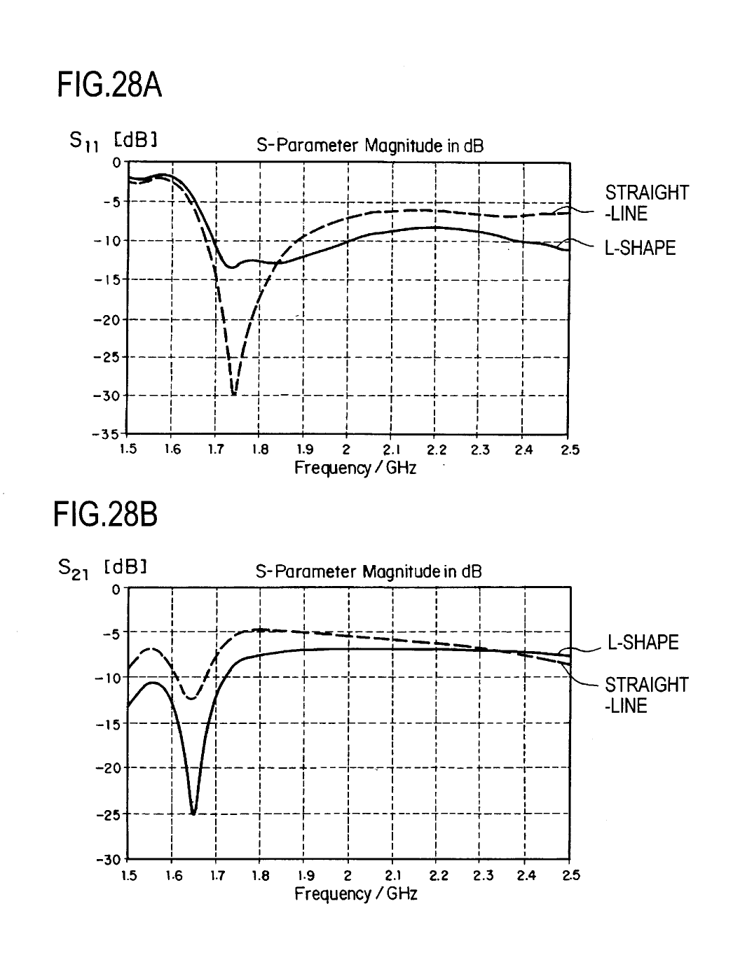

FIG. 28A and FIG. 28B respectively illustrate simulation results for parameter S₁₁ and for parameter S₂₁. In both cases, the simulation method is similar to that of the first example or similar.

As illustrated in FIG. 28A, with respect to the parameter S₁₁, when the frequency of the AC voltage fed from the first feed point 16-1 was from “1.9 GHz” to “2.5 GHz”, the numerical value was lower for the L-shape antenna elements 14-1 and 14-2 than for the straight-line shape antenna elements 14-1 and 14-2. Moreover, at frequencies equal to or greater than “1.7 GHz”, the parameter S₁₁ was equal to or less than the reference threshold “−6 dB”.

As illustrated in FIG. 28B, with respect to the parameter S₂₁, a lower numerical value was obtained for the L shape than for the straight-line shape at frequencies from “1.5 GHz” to “2.3 GHz”. With respect to coupling, simulation results could be obtained indicating the L-shape was more improved over the straight-line shape than matching over a broad frequency band. Further, the parameter S₂₁ remained at a numerical value equal to or less than the reference threshold “−6 dB” from “1.5 GHz” to “2.5 GHz”.

Hence characteristics for the antenna apparatus 10 including L-shape antenna elements 14-1 and 14-2 could be obtained for matching which, when the frequency of radio signals transmitted or received is from “1.7 GHz” to “2.5 GHz”, are on average a specific value, or are equal to or greater than a specific value. Further, characteristics for the antenna apparatus 10 including L-shape antenna elements 14-1 and 14-2 could be obtained for coupling, when the frequency of radio signals transmitted or received is from “1.5 GHz” to “2.5 GHz”, which are on average a specific value, or are equal to or greater than a specific value.

### Seventh Example

Next, a seventh example is explained. The seventh example is an example relating to a radio terminal apparatus 100 including an antenna apparatus 10.

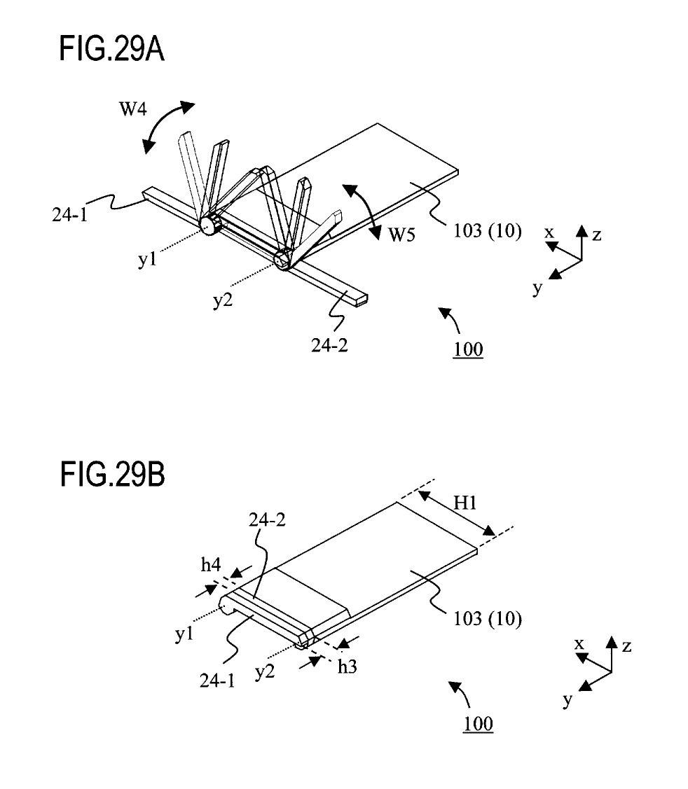

FIG. 29A and FIG. 29B are perspective views of the radio terminal apparatus 100, and illustrate the manner of rotation. The radio terminal apparatus 100 has a housing 103 and antenna units 24-1 and 24-2.

The housing 103 accommodates the antenna apparatus 10 therein.

The antenna units 24-1 and 24-2 (or the first antenna unit 24-1 and second antenna unit 24-2) accommodate, among the housing 103, the bent units 14-1b and 14-2b of the antenna elements 14-1 and 14-2. The antenna units 24-1 and 24-2 can rotate in the W4 direction and the W5 direction about the y1 axis and the y2 axis (or the fixed units 14-1a and 14-1b) respectively, as illustrated in FIG. 29A. Further, as illustrated in FIG. 29B, the antenna units 24-1 and 24-2 can be housed within the width H1 of the radio terminal apparatus 100 by rotating. For this reason, the length in the y-axis direction h3 of the first antenna unit 24-1 is longer than the length in the y-axis direction h4 of the second antenna unit 24-2. Because it is sufficient that the antenna units 24-1 and 24-2 can be housed within the width H1, the length h4 of the second antenna unit 24-2 may be longer than the length h3 of the first antenna unit 24-1.

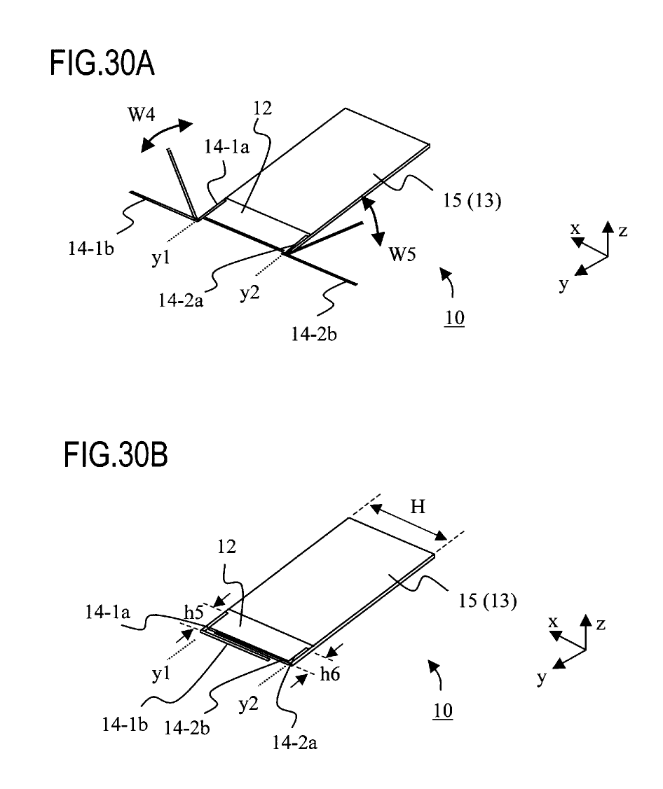

FIG. 30A and FIG. 30B are perspective views of the antenna apparatus 10, and illustrate the manner of rotation. The bent units 14-1b and 14-2b of the antenna elements 14-1 and 14-2 can rotate in the direction W4 and the direction W5 about the y1 axis and y2 axis, respectively, accompanying rotation of the antenna units 24-1 and 24-2, as illustrated in FIG. 30A. The bent units 14-1b and 14-2b can be housed within the width H of the antenna apparatus 10 by rotation, as illustrated in FIG. 30B. For this reason, the length h5 in the y-axis direction of the first fixed unit 14-1a is longer than the length h6 in the y-axis direction of the second fixed unit 14-2a. It is sufficient that the bent units 14-1b and 14-2b can be housed within the width H, so that the length h6 in the y-axis direction of the second fixed unit 14-2a may be longer than the length h5 of the first fixed unit 14-1a.

### Eighth Example

Next, an eighth example is explained. The above-described examples were examples in which the antenna apparatus 10 had two sets, where one set includes a first antenna element 14-1, first feed point 16-1, and first stub 18-1. In addition, the antenna apparatus 10 may have three or more sets.

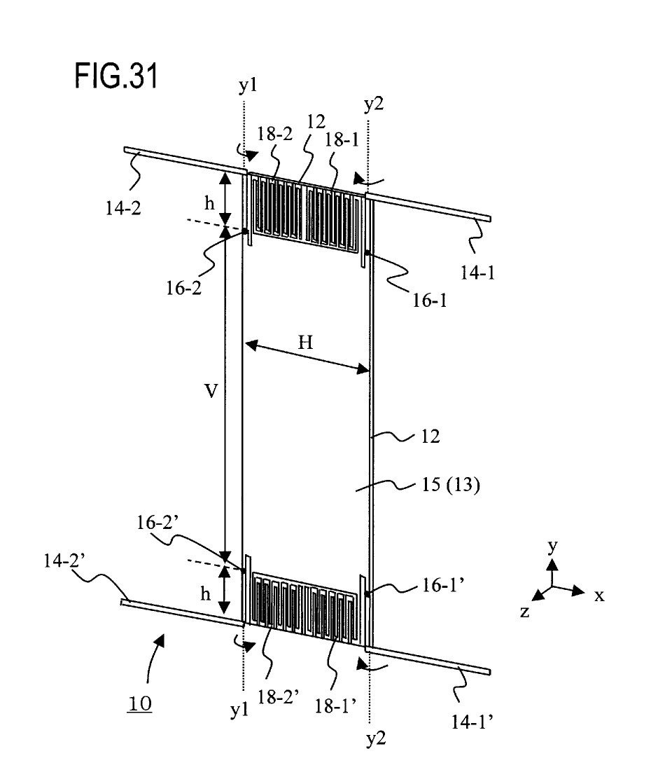

FIG. 31 is a perspective view of an antenna apparatus 10 including four sets. The antenna apparatus 10 also has, below a ground pattern in the y-axis direction, antenna elements 14-1′ and 14-2′, feed points 16-1′ and 16-2′, and stubs 18-1′ and 18-2′.

The antenna elements 14-1′ and 14-2′ are also provided to enable rotation about the y1 axis and y2 axis respectively. Further, the feed points 16-1′ and 16-2′ are also provided on the substrate 12 so as to be in contact with the antenna elements 14-1′ and 14-2′. Further, the stubs 18-1′ and 18-2′ also have shapes similar to those in the above-described examples. In this case, the antenna aperture 10 includes for example a connector which is connected to the housing of the radio terminal apparatus 100 in the center of the ground pattern 15, and is loaded into or accommodated within the radio terminal apparatus 100 by this connector.

The example illustrated in FIG. 31 has four sets; but by for example deleting the antenna element 14-2′, feed point 16-2′, and stub 18-2′, an antenna apparatus 10 having three sets can be obtained. Further, an antenna element, feed point, and stub can also be provided on a side of the ground pattern 15, so that an antenna apparatus 10 having five or more sets can be obtained. In this way, this antenna apparatus 10 can be made to have two or more sets of an antenna element, feed point, and stub.

### Ninth Example

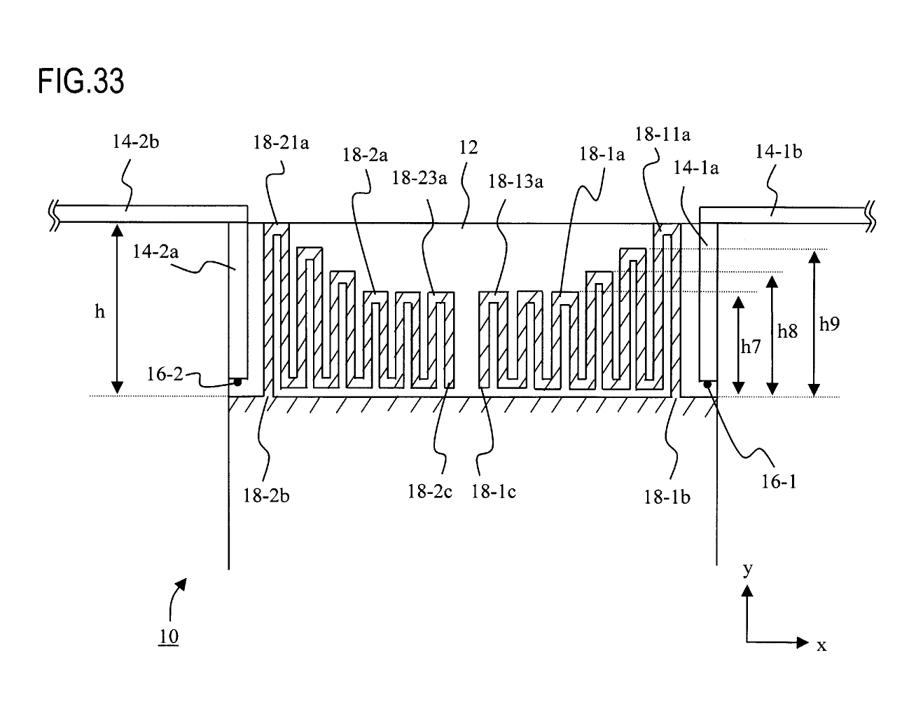

Next, a ninth example is explained. The ninth example is another example relating to the shape of the stubs 18-1 and 18-2. FIG. 33 is a partial enlarged view of an antenna apparatus 10.

As illustrated in FIG. 33, the length h in the y-axis direction (or the long-side direction) of the meander units 18-11a and 18-21a closest to the fixed units 14-1a and 14-2a of the antenna elements 14-1 and 14-2 is longer than any other meander unit. Further, the length gradually decreases with increasing distance from the antenna elements 14-1 and 14-2, and the length h7 in the y-axis direction of the meander units 18-13a and 18-23a farthest from the antenna elements 14-1 and 14-2 is the shortest compared with the other meander units. In the example of FIG. 33, the lengths in the y-axis direction are in the relation h7<h8<h9<h.

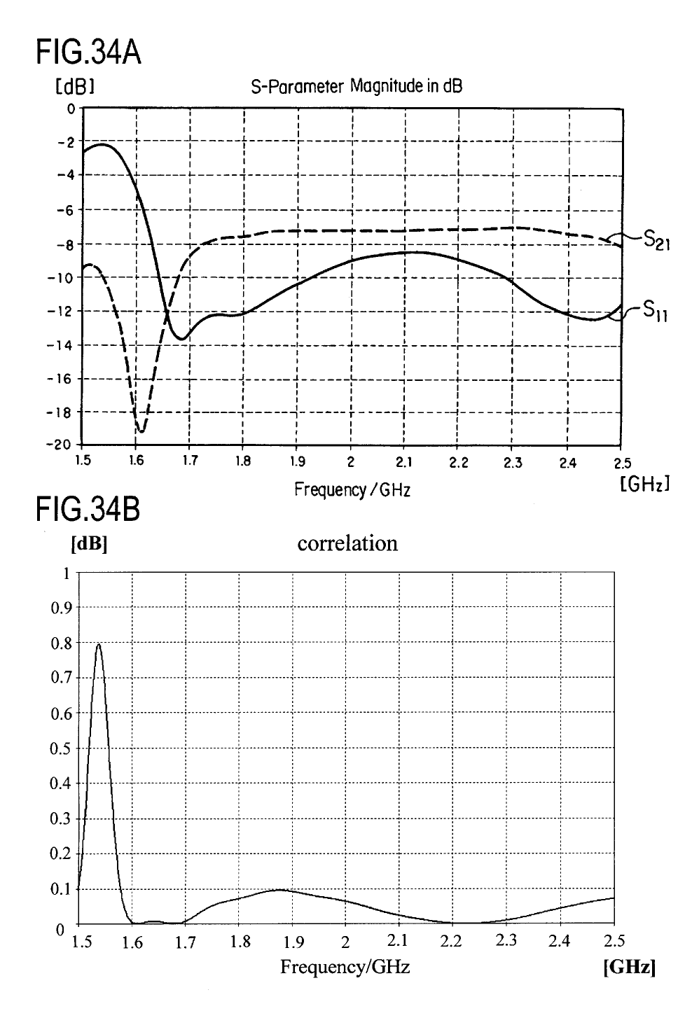

FIG. 34A illustrates simulation results for the parameters S₁₁ and S₂₁ of this antenna apparatus 10, and FIG. 34B illustrates simulation results for the correlation factors. Simulations were performed similarly to those of the first example.

In FIG. 34A, the solid line and dashed line illustrate simulation results for the parameter S₁₁ and the parameter S₂₁ respectively. Similarly to the first example and similar, if the allowable maximum threshold with respect to matching or coupling of the antenna elements 14-1 and 14-2 is “−6 dB” (reference threshold), then in FIG. 34A the values remain equal to or below this reference threshold at “1.7 GHz” and above. Hence for the antenna apparatus 10 of the ninth example, characteristics equal to or above a specific value can be obtained even when radio signals having a frequency of “1.7 GHz” or above are transmitted or received.

Further, as illustrated in FIG. 34B, with respect to the correlation factors also, simulation results were obtained in which the correlation factors was low at frequencies of “1.6 GHz” and above compared with an antenna apparatus 10 without stubs 18-1 and 18-2 (for example, the dashed line in FIG. 6). Hence for the antenna apparatus 10 of the ninth example, characteristics for correlation equal to or above a specific value could be obtained when the frequency of radio signals for transmission or reception is “1.6 GHz” or higher.

### Tenth Example

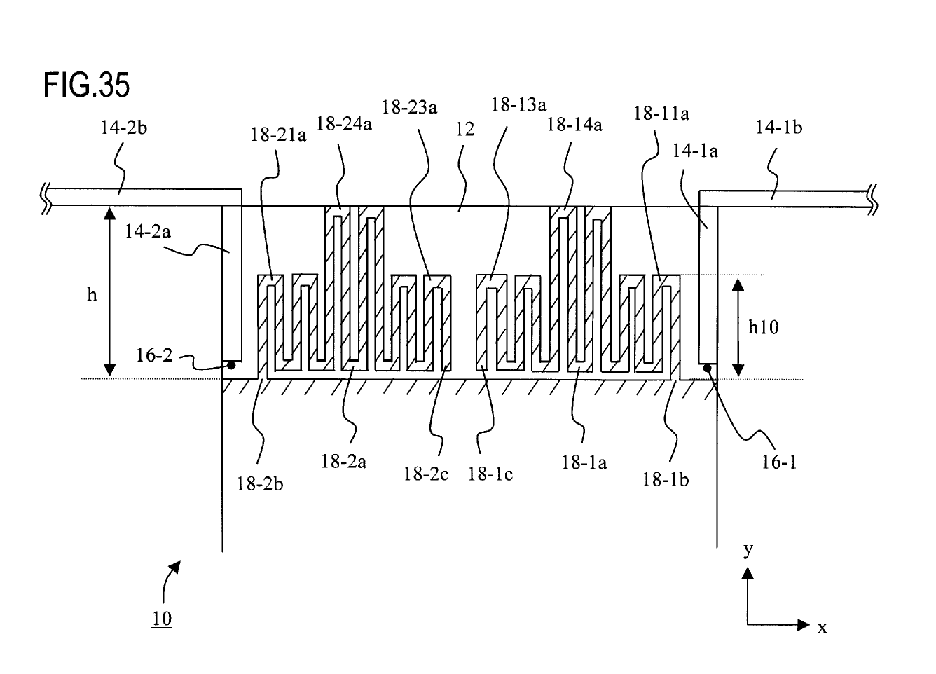

Next, a tenth example is explained. The tenth example is another example relating to the shape of stubs 18-1 and 18-2. FIG. 35 is a partial enlarged view of an antenna apparatus 10.

As illustrated in FIG. 35, between the meander units 18-11a and 18-21a closest to the fixed units 14-1a and 14-2a of the antenna elements 14-1 and 14-2, and the farthest meander units 18-13a and 18-23a, are meander units 18-1a and 18-2a. The length h in the y-axis direction (or long-side direction) of these meander units 18-14a and 18-24a is longer than any other meander unit. In the example of FIG. 35, the lengths in the y-axis direction of the meander units 18-11a and 18-21a and of the meander units 18-13a and 18-23a are the same h10 (h10<h), but the lengths may be different.

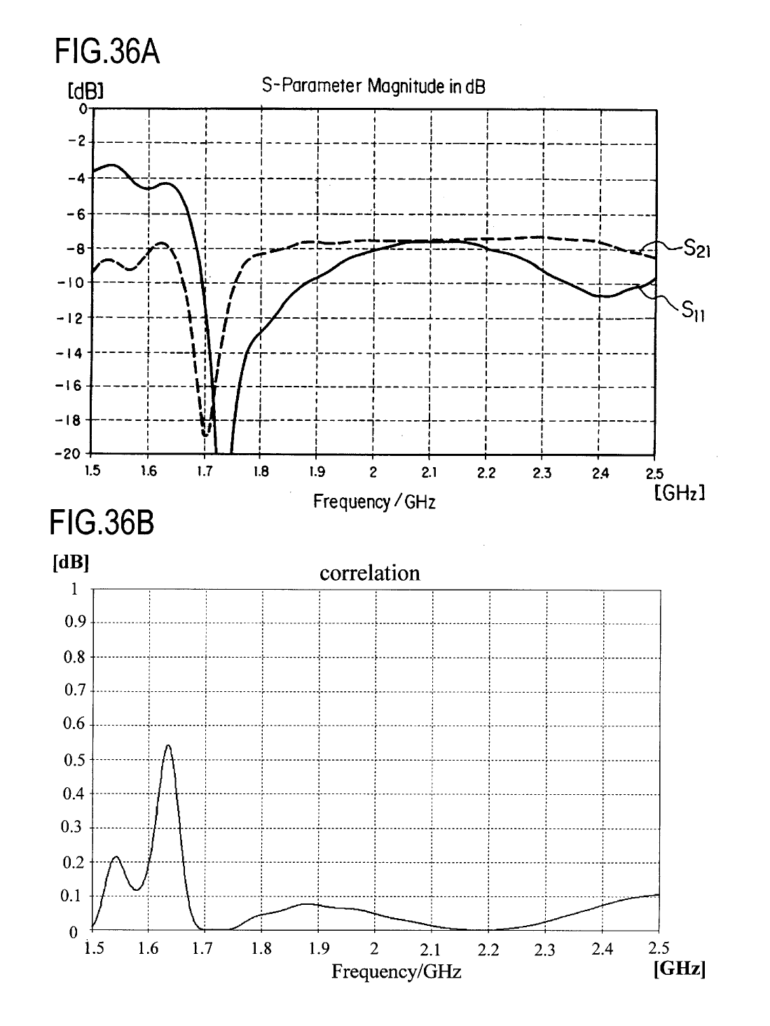

FIG. 36A and FIG. 36B illustrate examples of simulation results for the parameters S₁₁ and S₂₁ and for the correlation factors respectively.

As illustrated in FIG. 36A, the two parameters S₁₁ and S₂₁ remain equal to or below the reference threshold “−6 dB”. Further, results were obtained indicating that both of the two parameters S₁₁ and S₂₁ were at extremely low values at frequency “1.7 GHz” compared with at other frequencies. From this, characteristics equal to or greater than a specific value can be obtained for the antenna apparatus 10 of this tenth example even when radio signals of frequency “1.7 GHz” or higher are transmitted or received. Further, more satisfactory characteristics can be obtained for the antenna apparatus 10 of this tenth example when transmitting or receiving radio signals at frequency “1.7 GHz” than at other frequencies.

Further, as illustrated in FIG. 36B, with respect to the correlation factors as well, simulation results were obtained indicating low correlation factors at frequencies of “1.7 GHz” and above compared with an antenna apparatus without stubs 18-1 and 18-2 (for example, the dashed line in FIG. 6). Hence characteristics for correlation equal to or above a specific value can be obtained for the antenna apparatus 10 of the tenth example when the frequency of radio signals to be transmitted or received is “1.7 GHz” or above.

### Other Examples

Further, in each of the above-described examples, an antenna apparatus 10 was explained as having a single substrate 12. An antenna apparatus 10 may have a plurality of substrates 12. Of these, a certain substrate 12 has for example a ground pattern 15 and antenna elements 14-1 and 14-2 and similar, as illustrated in FIG. 1 and similar, and this ground pattern 15 forms a ground for the elements and similar on the other substrates 12.

Also, in each of the above-described examples, explanations were given in which antenna elements 14-1 and 14-2, feed points 16-1 and 16-2, and stubs 18-1 and 18-2 are arranged on the top surface of a substrate 12. For example, antenna elements 14-1 and 14-2 and feed points 16-1 and 16-2 can be arranged on the top surface of the substrate 12, and stubs 18-1 and 18-2 and the ground pattern 15 can be arranged on the bottom surface.

An antenna apparatus and radio terminal apparatus with reduced space usage or greater compactness can be provided. Further, an antenna apparatus and radio terminal apparatus from which specific characteristics can be obtained can be provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An antenna apparatus, comprising:
a substrate;
an antenna element which is arranged on the substrate and transmits or receives a radio signal;
a feed point which is connected to the antenna element and feeds a current or a voltage to the antenna element; and
a wiring pattern, one end of which is connected to a ground pattern formed on a portion of the substrate,
wherein two or more sets of the antenna element, the feed point, and the wiring pattern is included if the antenna element, the feed point, and the wiring pattern form one set.

2. The antenna apparatus according to claim 1, wherein a portion of the wiring pattern is formed as a meander line.

3. The antenna apparatus according to claim 2, wherein a distance between the meander line which is closest to the antenna element among portions of the meander line, and the antenna element is equal to or less than a threshold value.

4. The antenna apparatus according to claim 1, wherein the ground pattern includes a slit.

5. The antenna apparatus according to claim 2, wherein all of lengths of portions of the meander line in a long-side direction are the same.

6. The antenna apparatus according to claim 2, wherein lengths of portions of the meander line in a long-side direction increase in accordance with increasing distance from the antenna element.

7. The antenna apparatus according to claim 2, wherein a length in a long-side direction of a first meander line which is closest to the antenna element among potions of the meander line is longer than a length in the long-side direction of a second meander line which is shortest among the potions of the meander line, and lengths in the long-side direction of the portions of the meander line other than the first and second meander lines increase in accordance with increasing distance from the antenna element.

8. The antenna apparatus according to claim 1, wherein the number of wiring patterns connected to the ground pattern in each of the sets is one or more.

9. The antenna apparatus according to claim 1, wherein
the antenna element includes a fixed unit fixed to the antenna apparatus and a bent unit bent in an L-shape, and
the bent unit is rotatable about the fixed unit and is accommodated within a width of the antenna apparatus by rotation of the bent unit.

10. The antenna apparatus according to claim 1, wherein the wiring pattern is arranged within the same plane as the ground pattern.

11. The antenna apparatus according to claim 1, wherein the wiring pattern is arranged within a plane which is perpendicular to the ground pattern.

12. The antenna apparatus according to claim 1, wherein the wiring pattern is formed by a conductive metal flat plane.

13. The antenna apparatus according to claim 1, wherein the wiring pattern is a stub.

14. The antenna apparatus according to claim 1, wherein the ground pattern is formed by a conductive metal flat plane.

15. The antenna apparatus according to claim 2, wherein lengths of portions of the meander line in a long-side direction decrease in accordance with increasing distance from the antenna element.

16. The antenna apparatus according to claim 2, wherein among portions of the meander line, a length of a third meander line in a long-side direction is longer than lengths of other portions of the meander line in the long-side direction, the third meander line being disposed between a first meander line which is closest to the antenna element and a second meander line which is farthest from the antenna element.

17. A radio terminal apparatus for transmitting or receiving a radio signal, comprising:
a housing; and
an antenna apparatus accommodated in the housing,
wherein
the antenna apparatus includes a substrate, an antenna element which is arranged on the substrate and transmits or receives the radio signal, a feed point which is connected to the antenna element and feeds a current or a voltage to the antenna element, and a wiring pattern one end of which is connected to a ground pattern formed on a portion of the substrate, and
two or more sets of the antenna element, the feed point, and the wiring pattern is included if the antenna element, the feed point, and the wiring pattern form one set.
